(19) United States
(12) Patent Application Publication
(10) Pub. No.: US 2026/0097421 A1
(43) Pub. Date: Apr. 9, 2026

(54) PROBABILITY SORTER

(71) Applicant: CYTONOME/ST, LLC, Lexington, MA (US)

(72) Inventor: Gary Durack, Urbana, IL (US)

(73) Assignee: CYTONOME/ST, LLC, Lexington, MA (US)

(21) Appl. No.: 19/260,036

(22) Filed: Jul. 3, 2025

Related U.S. Application Data
(60) Provisional application No. 63/667,344, filed on Jul. 3, 2024.

(51) Int. Cl. B07C 5/342; B01L 3/00

(52) U.S. Cl. CPC B07C 5/3425; B01L 3/502761; B01L 2200/0652

(57) ABSTRACT

System and a computer-implemented method for sorting particles in a fluid stream are provided. An example method can include establishing a desired sort purity for a target subpopulation of particles in the fluid stream. The method can further include assigning an average probability value to a sortable unit of fluid containing one or more particles. The method can further include collecting sortable units of fluid having a cumulative probability value equal to or higher than the desired sort purity.

### RELATED APPLICATION

This application claims the benefit of, and priority to, United States Provisional Ser. No. 63/667,344 , filed Jul. 3, 2024, entitled “Probability Sorter”, the contents of which are incorporated herein in their entirety.

### BACKGROUND

Particle classification and sorting is a subject of considerable research and commercial interest. For example, particle classification and sorting can be applied for gender offspring selection by classification and selection of X- or Y-bearing spermatozoa. For another example, particle classification and sorting can be used to separate cancerous from non-cancerous cells. Particle sorting systems can be used for particle classification and sorting by separating particles (e.g., cells) of interest from a general population of particles flowing in a fluid stream. Such systems can operate on a “detect-decide-deflect” principle wherein particles in the stream are detected, a decision is made as to whether the particle is a particle of interest, and the particles of interest are deflected into one or more keep paths. However, conventional technologies for particle classification and sorting, such as separating spermatozoa into X-chromosome bearing and Y-chromosome bearing population, can result in low-purity particle populations (e.g., low-purity spermatozoa populations).

### SUMMARY

Systems and methods for sorting particles are taught herein. An example method can include measuring one or more characteristics of one or more particles in a sortable unit of fluid. The method can further include determining, based on the one or more characteristics, a probability value for the sortable unit of fluid, the probability value indicating how likely the sortable unit of fluid belongs to a particle classification. The method can include sorting the sortable unit of fluid based on the probability value.

Another example method for sorting particles can include measuring one or more first characteristics of one or more first particles in a first sortable unit of fluid. The method can further include determining, based on the one or more first characteristics, a first probability value for the first sortable unit of fluid, the first probability value indicating how likely the first sortable unit of fluid belongs to a first particle classification. The method can include accessing a probability matrix defining a first desired population of a first plurality of particles. The method can include sorting the first sortable unit of fluid, based on the probability value matrix and the first probability value of the first sortable unit of fluid.

In some embodiments, the method can further include measuring one or more second characteristics of one or more second particles in a second sortable unit of fluid. The method can include determining, based on the one or more second characteristics, a second probability value for the second sortable unit, the second probability value indicating how likely the second sortable unit belongs to a second particle classification. The method can include accessing the probability matrix, which further defines a second desired population of a second plurality of particles. The method can include sorting the second sortable unit of fluid, based on the probability value matrix and the second probability value of the sortable unit of fluid.

### BRIEF DESCRIPTION OF THE DRAWINGS

It is to be noted that the various features and combinations of features described below and illustrated in the figures can be arranged and/organized differently to result in embodiments which are still within the spirit and scope of the present disclosure. Further, components in the drawings are not necessarily to scale nor are they necessarily rendered proportionally, emphasis instead being placed upon clearly illustrating the relevant principles.

Even further, various features may not be shown in certain figures in order to simplify the illustrations. Additionally, for the purposes of describing or showing items between layers or behind other elements or for generally simplifying the views in certain of these figures, various components or elements may be illustrated as transparent or using cross-hatching or other standard drawing techniques may be presented. To assist those of ordinary skill in the art in making and using the disclosed systems, assemblies and methods, reference is made to the appended figures.

FIG. 1 is a flowchart illustrating processing steps for sorting particles in accordance with some embodiments.

FIG. 2A is a flowchart illustrating processing steps for sorting particles in accordance with some embodiments.

FIG. 2B is a flowchart illustrating processing steps for sorting at least two sortable units in accordance with some embodiments.

FIG. 3 illustrates forward fluorescence measurement (FFL) of particles producing Gaussian distributions.

FIG. 4 illustrates a table (Table 1) of parameters for a computer model of the two Gaussian distributions 102 and 104 in FIG. 3, with means separated by 3.8%, and peak to valley ratio (PVR) values ranging from 60% to 80%.

FIG. 5A is a graph of a fraction of actual X particles as functions of PVR that be correctly classified as “positive”for sorting to 90% and 95% purities.

FIG. 5B is a graph of a fraction of actual X particles as functions of PVR that be correctly classified as “positive”for sorting to 90% and 95% purities.

FIG. 6A illustrates a histogram of FFL intensity for a set of well aligned sperm cells as a function of a number of cells and a histogram of FFL intensity for a set of well aligned sperm cells above a probability distribution for Pr(X) as a function of the FFL intensity in the histogram.

FIG. 6B is a graph illustrating that a dual Gaussian model is applied to raw FFL data.

FIG. 7 is a flowchart illustrating processing steps for executing a dual Gaussian model in accordance with some embodiments.

FIG. 8 is a block diagram that summarize processing steps for probability sorting in accordance with some embodiments.

FIG. 9 illustrates a Quad detector for orientation and calculation of SP-x and SP-y

FIG. 10A is an orientation plot in accordance with some embodiments.

FIG. 10B is a conventional FFL vs side fluorescence (SFL) plot of sperm measurements.

FIG. 11A is a graph illustrating contiguous regions outputted from an algorithm to automatically segment the orientation scatter plot distribution as illustrated in FIG. 10A.

FIG. 11B is a graph illustrating a fine segmentation having independent output for each sort regions in accordance with some embodiments.

FIG. 12 illustrates an orientation scatter plot distribution segmented into eight separate sort regions in accordance with some embodiments.

FIG. 13 illustrates a portion (Table 2) of a lookup table created by a probability model and used to process particles in accordance with some embodiments.

FIG. 14 illustrates an interface having an orientation plot generated by applying the particle processing system as taught herein to an equine sample.

FIG. 15 is a scatter plot of FFL vs SFL for bovine sperm cells.

FIG. 16 is a graph illustrating raw data for measured FFL intensity for particles falling in each of thirty-two orientation plot segments.

FIG. 17 is an FFL vs. SFL scatter plot with FFL intensity “normalized” or corrected for an measurement error caused by orientation.

FIG. 18A is a plot of raw data of an FFL measurement.

FIG. 18B is a plot of normalized FFL measurement data.

FIG. 19 is a graph illustrating a variation in measured SFL intensity as a function of FP-x.

FIG. 20A is a graph illustrating normalized FFL measurement without SFL correction.

FIG. 20B is a graph illustrating normalized FFL measurement with SFL correction.

FIG. 21 is a block diagram of an exemplary computing device that can be used to perform one or more steps of the methods provided by exemplary embodiments.

FIG. 22 is a diagram illustrating computer hardware and network components on which a system can be implemented.

### DETAILED DESCRIPTION

The present disclosure relates to systems and methods for particle classification, sortable unit classification, coincidence management, and management of particle collection purity for a particle sorter.

As used herein, the term “particles” can include, but is not limited to, cells (e.g., sperm cells, blood platelets, white blood cells, tumorous cells, embryonic cells, stem cells, spermatozoa, etc.), organelles, and multi-cellular organisms. Particles can include liposomes, proteoliposomes, yeast, bacteria, viruses, pollens, algae, or the like. Additionally, particles can include genetic material, RNA, DNA, fragments, proteins, etc. Particles can also refer to non-biological particles. For example, particles can include metals, minerals, polymeric substances, glasses, ceramics, composites, or the like. Particles can be naturally occurring or man-made. Particles can also refer to synthetic beads (e.g., polystyrene), for example, beads provided with fluorochrome conjugated antibodies. For the purpose of clarity the term particles can be used to refer to any cells or other particles intended to be sorted in a microfluidic device. As used below, the term “cells” should be construed as being generic to any type of particle described above absent a specific intention to limit the term to cells specifically. As described below, certain aspects of the present disclosure may be particularly useful for sorting and analyzing aspherical particles, particularly cells that need to be oriented for sorting, such as sperm cells.

As used herein, a “sortable unit” is a unit of fluid flowing within a fluid stream in the systems taught herein. A “sortable fluid segment” is a sortable unit of fluid that forms part of a continuous stream. A “droplet” is a sortable unit of fluid that forms part of a discretized stream. In other words, a “sortable fluid segment” shares a fluidic boundary with at least one neighboring sortable fluid segment while a “droplet” does not share a fluidic boundary with a neighboring droplet. “Droplet” is commonly associated with sortable units downstream of a sorter in jet-in-air type particle sorters where the units of fluid are suspended in air. “Sortable fluid segment” is commonly associated with expected sortable units upstream of the sorter in jet-in-air and on-chip systems as well as with sortable units downstream of the sorter in on-chip systems. An “expected sortable unit” is a volume of fluid (i.e., a sortable fluid segment) upstream of a sorter or separator in the system that is predicted or expected to correspond to a resulting sortable unit downstream of the sorter or separator. The expected sortable unit can be defined in some computational contexts as being associated with a time segment during which particles of interest are measured at an inspection zone of the system based on sort delay.

As used herein, a “feature space” is the n-dimensional orthogonal space formed by n features as the axes. With respect to a feature space, the features can be specific characteristics corresponding to cells or a registered as event generally detected as a pulse. Such features may be measured values or calculated values pertaining to those events. By way of a non-limiting example, some features described in this application which may serve as axis for a feature space including: peak forward fluorescence (pulse height), peak side fluorescence (pulse height), integrated area of a forward fluorescence pulse (pulse area), integrated areas of a side fluorescence pulse (pulse area); normalized forward fluorescence, corrected side fluorescence, FP-x (a calculated valued reflecting the position of the center of intensity on a forward detector on a first axis), FP-y (a calculated valued reflecting the position of the center of intensity on a forward detector on a second orthogonal axis), SP-x (a calculated valued reflecting the position of the center of intensity on a side detector on a first axis), and SP-y (a calculated valued reflecting the position of the center of intensity on a side detector on a second orthogonal axis). A one-dimensional feature space may be represented in a histogram which can illustrate the frequency at which certain values for the feature of interest occur. Two-dimensional feature spaces may be represented as bivariate plots with two axis and can illustrate the characteristics of events or pulses with respect to two features of interest. It may further be appreciated that with respect to a feature space a “segment” refers to a bounded region or a bounded range of values within that feature space. Depending on the function of a segment in a representation of a feature space (such as in a plot), it may be referred to as a gate or a sort region.

The present disclosure relates to a method and apparatus for particle classification, sortable unit classification, coincidence management, and management of particle collection purity. The methods and systems taught herein provide a particle processing systems and methods that sort particles based on a sort probability. The particle processing systems and methods as taught herein can automatically adjust a sort operation in real time to optimize the yield of a targeted particle population. The particle processing systems as taught herein can be used for particle classifications, sortable unit classifications, particle orientation measurements, and particle core stream position locations amongst other particle processing operations and functions.

The particle processing systems as taught herein can provide the following advantages:

Particle classification as taught herein can be automated and objective. Operators do not need to draw classification regions.

Particle classification taught herein cannot be not binary, but continuous. Each particle detected by the particle processing system can be assigned one or more probability values equal to the probability that the sortable unit is a particle type (e.g., cell type) targeted for particle sorting. For example, with respect to sperm cell sorting, each cell can be assigned a Pr(X) that refers to a probability that the sperm cell contains XX chromosomes and a Pr(Y) that refers to a probability that the sperm cell contains XY chromosomes based fluorescence measurements which correlate to DNA content.

The particle processing system as taught herein can be self-optimizing and continually updating based on the current performance of the instrument and the current quality of samples. A computer model (e.g., a machine/deep learning model, a neural network, etc.) included in the particle processing system can continuously process the most recent particle measurements, update model parameters, and generate revised probability estimates as a function of DNA content. These probability estimates, derived from large sets of particles that passed through the particle processing system seconds earlier, can be then used in real-time to classify particles one by one (i.e. assignment of Pr(X) and Pr(Y) to each sperm cell). The particle processing system as taught herein can continuously optimize the performance of particle classification, self-adjusting for variation in the instrument or the sample. For example, if optical alignment changes to increase precision, then in seconds the computer model can adjust probability estimates to take advantage of the improved measurement precision.

In some embodiments, the computer model as taught herein can self-adjust to accommodate sperm cell orientation. It can be well understood that measurement precision degrades for particles that pass through the laser focus at less than optimal axial orientation. Probability estimates can be normalized for the orientation variable or separate probability estimates can be calculated for sets of particles that have the same mis-orientation.

Sortable unit classification (e.g., droplet classification) as taught herein for sorting particles is not based on Boolean rules. The particle processing system as taught herein can use average probabilities (e.g., the probability that a particular particle in a sortable unit can be a member of the subpopulation, probability that any collected particles in a sortable unit can be a member of the associated sub-population, and if there are N subpopulations there can be N probability values assigned to a particle (one for each sub-population)) of the particles in a sortable unit (e.g., droplet) to calculate a potential impact of the sortable unit on the cumulative particle purity of the collected sortable units. An average Pr(AD)_{avg} and Pr(BD)_{avg} for each sortable unit can be calculated by summing respective probabilities and dividing by the number of particles in the sortable unit. A particle count and a running average Pr(AT)_{avg} and Pr(BT)_{avg} for a keep vessel can be maintained throughout the probability sort. Pr(AT)_{avg} and Pr(BT)_{avg} can be essentially high-precision estimates of particles A and B purities, respectively. These purity estimates can provide real-time feedback to the sortable unit classification algorithm, enabling it to maximize the number of target particles sorted into a keep vessel. Rules, based on the relationship between the sortable unit probabilities and keep vessel probabilities can be implemented. For example, if a keep vessel must be >95% XX sperm cells at the end of the sorting, then any sortable unit can be sorted into a keep vessel that does not cause Pr(AT)_{avg} of the keep vessel to fall below 0.95 (regardless of how many particles are in the sortable unit or individual probability values for those particles). This can produce 95% purity for XX sperm cells in the keep vessel. Many other probability-based rules can be implemented.

The particle processing system as taught herein can be implemented through a computing architecture having more than one processors or a single processor with multiple cores or other architecture such as a FPGA or ASIC. The computing architecture combines model data (e.g., model data from offline processing or real time processing by the main processor) on one or more computer processors, while maintaining a high-speed, real-time, measurement and sorting pipeline (e.g., using one or more processors having suitable processing speed and power, such as programmable processor or a field programmable gate arrays (FPGA) or other type of processor). The processor(s) can receive a measurement pipeline of data, implement the computer model as taught herein on the most recent data, and then update lookup tables or other data structures containing probability information in memory. The probabilities that the processor assigns to particles in the real-time pipeline can come from these lookup tables, which can be based on measurement data collected a few seconds earlier.

The systems and methods as taught herein can provide an automated and rapidly self-correcting system for gender-specific sperm cell classification.

In some embodiments, the particle processing system as taught herein can provide a method to classify particles for sorting by assigning to each measured particle a probability value equal to each particle's probability of being the particle type targeted for sorting. The particle processing systems taught herein can use one or more processors to host a computer model when applied to particle measurement data from the particle processing system and can produce accurate, predictive probabilities as a function of one or more the particle measurement parameter values. The particle processing systems as taught herein can execute or carry out a methodology to continuously update the probability functions, using recent measurement data streamed from the particle sorter, such that these functions continuously reflect the current state of instrument measurement performance and sample quality, for example sample staining quality. The particle processing systems as taught herein can execute or carry out a methodology to download the probability functions into a real time sort processor, such as an FPGA or programmable processor, so that the real time sort processor can make use of these functions for the purpose of particle classification. The particle processing systems as taught herein can also use the probability functions in a real-time sort processor, such as an FPGA or programmable processor, to assign a probability value to a particle in real-time based on one or more of that particle's measured parameter values. In some embodiments, the particle processing systems as taught herein can include an offline processor and a real-time sort processor that implements the functionality as described in above in a fully automated manner, to continuously self-optimize the accuracy of the assignment of particle classification probabilities to particles, and by doing so optimizes the accuracy and efficiency of the particle sorter. Likewise, in some embodiments, the particle processing systems as taught herein can include one or processors that implements the functionality as described in above in a fully automated real-time manner, to continuously self-optimize the accuracy of the assignment of particle classification probabilities to particles, and by doing so optimizes the accuracy and efficiency of the particle sorter. The particle processing systems as taught herein can also execute or perform a methodology to calculate and assign an average probability value to a sortable unit based on the average of individual probabilities assigned to the particles contained in that sortable unit. The particle processing systems as taught herein can also execute or perform a methodology, on a sortable unit basis, for example, a drop-by-drop basis, to calculate average probability values for all particles for sortable units previously sorted into a keep vessel such that the average probability values calculated for the keep vessel correlate to the actual sort purities for the particle types associated with said probabilities at the moment of calculation (e.g., Average Pr(X) for a tube=the % X purity of the keep vessel and the average Pr(Y)). The particle processing systems as taught herein can also execute or perform a methodology to determine the assignment of a sortable unit to a specific sort stream in real-time (i.e. into one of several keep vessels or waste vessels) through an algorithm that uses the average probability of the sortable unit to be sorted, the current average probability of the keep vessels, and other particle or sortable unit classification information. The particle processing systems as taught herein can also execute or perform a methodology to automatically classify cells, for example, sperm cells, as to whether they are dead, live, or aggregated (e.g., using side fluorescence measurements, or the like). The particle processing systems as taught herein can also execute or carry out a methodology to classify a cell, for example, a sperm cell, in real time, with regard to its axial orientation during measurement in the particle sorter laser. The particle processing systems as taught herein can also execute or carry out a methodology to automatically segment particle orientation measurements into multiple (e.g., 32, or more or less than 32) bounded regions or segments. The particle processing systems as taught herein can also execute or perform a methodology to classify each particle flowing through the particle sorter in real time, based on its measured values, as to its membership in one, and only one, of the orientation segments. The particle processing systems as taught herein can be applied for separate orientation classifications for the purpose of increasing particle sorter accuracy and efficiency for example for sperm cell sorting. The particle processing systems as taught herein can also execute or perform a methodology to use an offline processor to calculate a mean forward fluorescence (FFL) intensity value for each of the orientation segments, and to determine correction factors that can correct FFL measured values for variation due to sperm cell orientation. The particle processing systems as taught herein can implement the correction factors calculated in a real-time sort processor so that the corrected FFL data may be used for particle classification. The particle processing systems as taught herein can provide a method to use dimensionless values (Sp-x, SP-y, FP-x, FP-y) that are insensitive to fluorescence intensity variation to measure cell particle orientation and to measure relative particle position in a core stream, even an elliptical core stream formed by the particle sorter orientation fluidic system. The particle processing systems as taught herein can execute or perform a methodology to correct measured side fluorescence (SFL) values for variation caused by variation in the distance that a particle is from the SFL optic (caused by its relative location in the sample core stream, for example, an elliptical sample core stream). The particle processing systems as taught herein can also execute or perform a methodology to “dial in” or to pre-select a sort purity that the particle sorter delivers for each sort keep vessel.

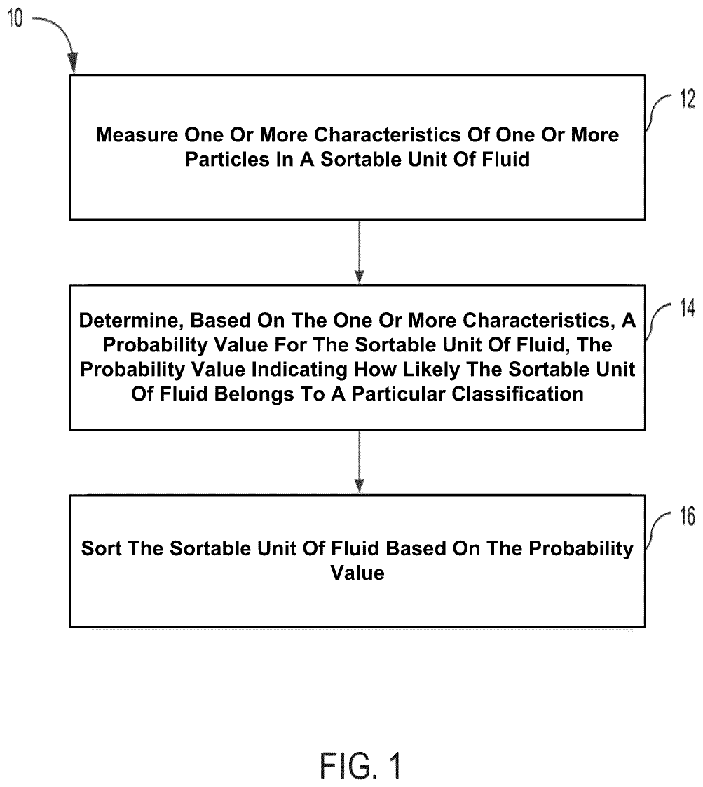

FIG. 1 is a flowchart illustrating processing steps 10 for processing particles in accordance with some embodiments. The following example is based on particle sorting. Nonetheless, the methods and systems taught herein are equally applicable to other particle processing techniques like, particle counting, determining particle characteristics, determining particle function, detecting microorganisms, such as bacteria, fungus or yeast, finding biomarkers (characteristics that indicate normal function), diagnosis and potential treatment of blood and bone marrow cancers and so on.

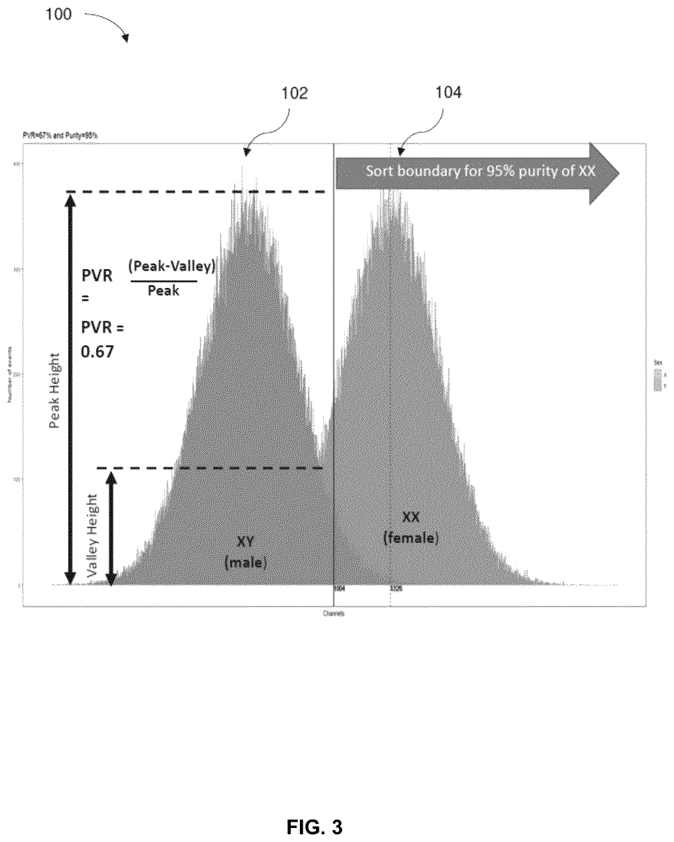

In step 12, a particle processing system as taught herein can measure one or more characteristics of one or more particles in a sortable unit of fluid. For example, the particle processing system can measure one or more characteristics (e.g., scatter, extinction, fluorescence including FFL, or SFL, orientation, or the like) of one or more particles in a sortable unit of fluid. Examples are described with respect to FIG. 3.

In step 14, the particle processing system can determine, based on the one or more characteristics, a probability value for the sortable unit of fluid. The probability value can indicate how likely the sortable unit of fluid belongs to a particle classification. Examples are described with respect to FIGS. 4, 6, 7, and 8.

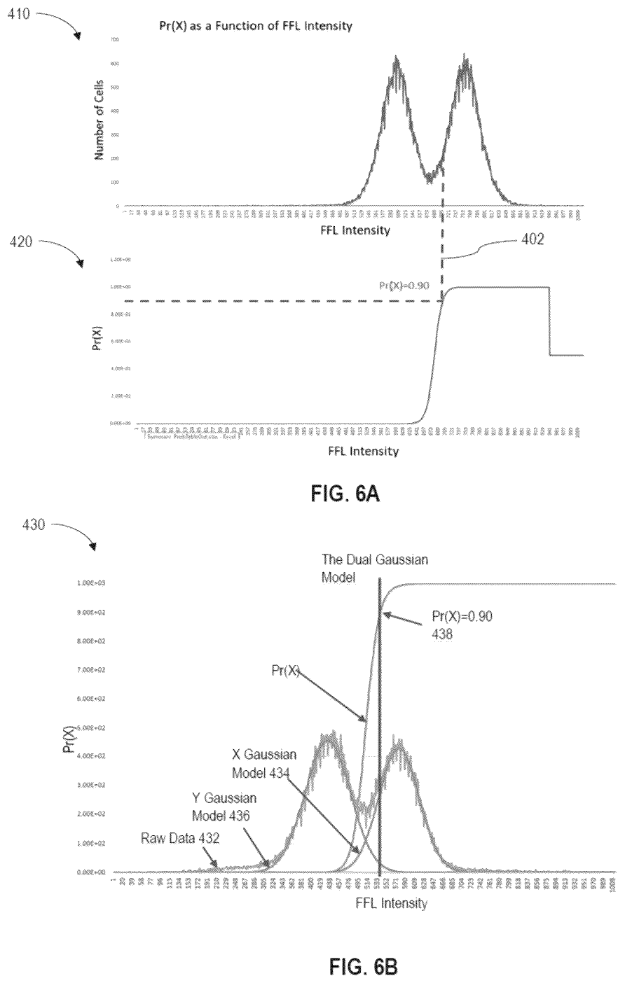

In step 16, the particle processing system can sort the sortable unit of fluid based on the probability value. Examples are described with respect to FIGS. 6A and 6B.

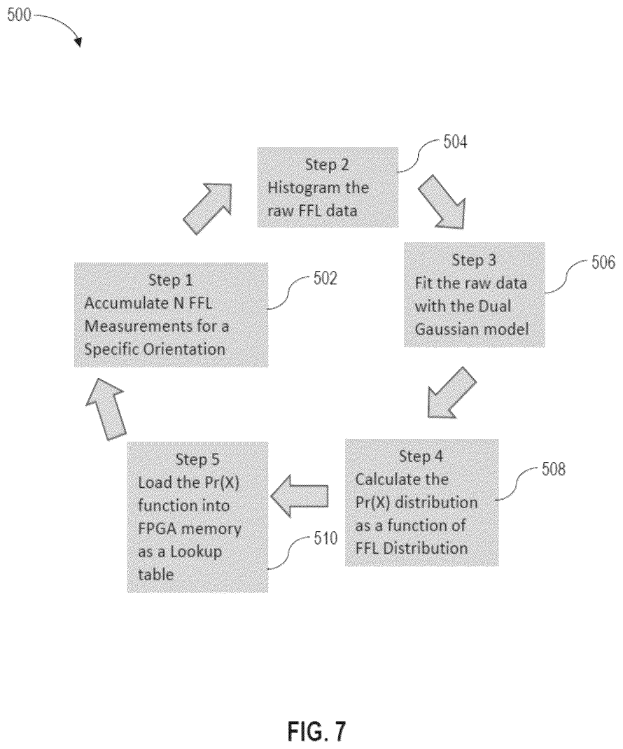

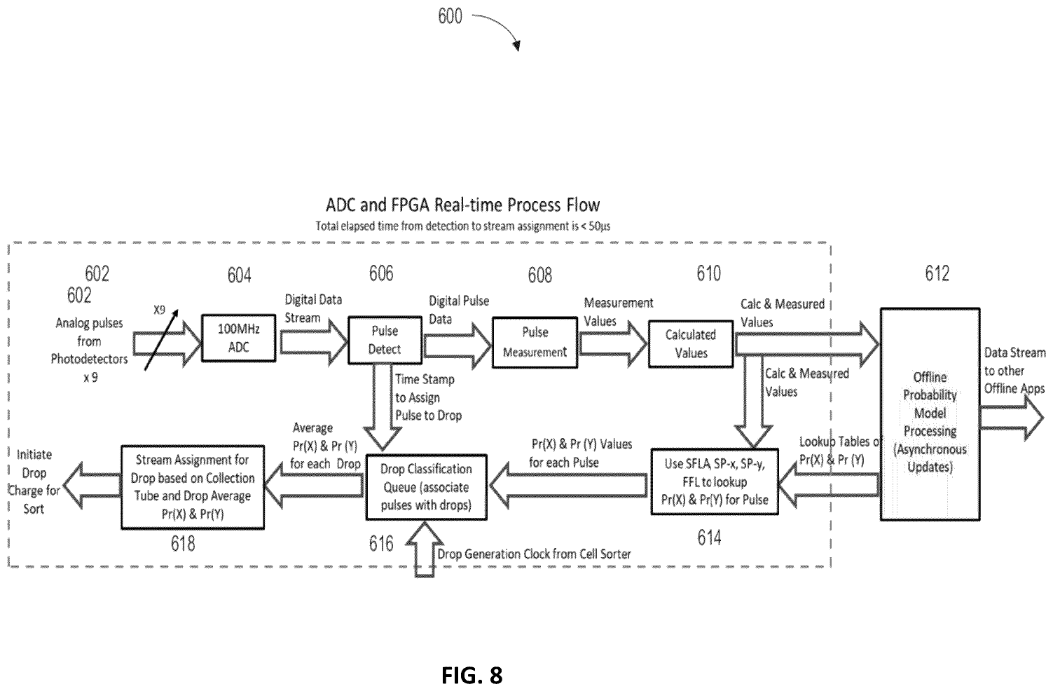

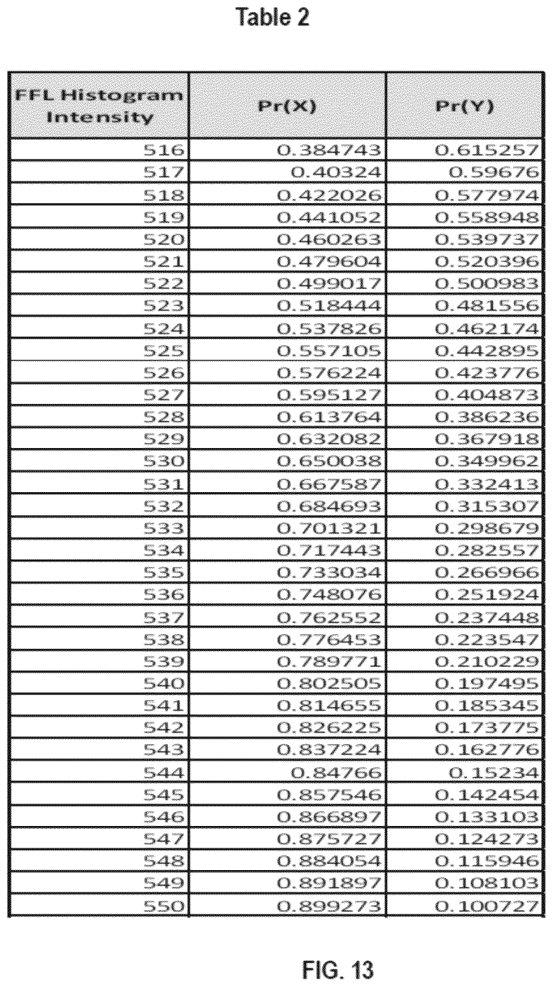

In some embodiments, the particle processing system can sort particles in the suitable unit. For example, the particle processing system can determine, based on the one or more characteristics, a respective probability value for each of the one or more particles in the sortable unit of fluid. The respective probability value can indicate how likely each of the one or more particles belongs to the particle classification. Examples are described with respect to FIGS. 1-8. In some embodiments, the probability value for the sortable unit of fluid can be determined based on the respective probability value for each of the one or more particles and a number of the one or more particles. Examples are described with respect to FIGS. 7 and 13. In some embodiments, the probability value for the sortable unit of fluid can be determined based on a computer model (e.g., artificial intelligence (AI) model or a computer). Examples are described with respect to FIGS. 4, 6, and 13. In some embodiments, the particle processing system can continually updating the computer model based on results from the sorting step in real time. Examples are described with respect to FIG. 8. In some embodiments, the probability value cam be determined in real time.

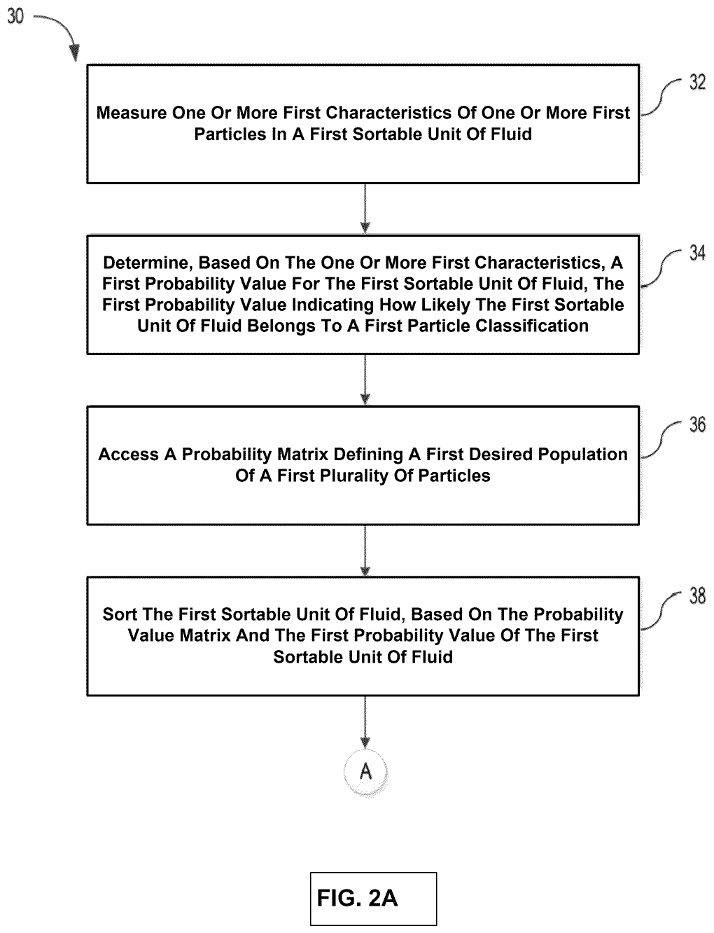

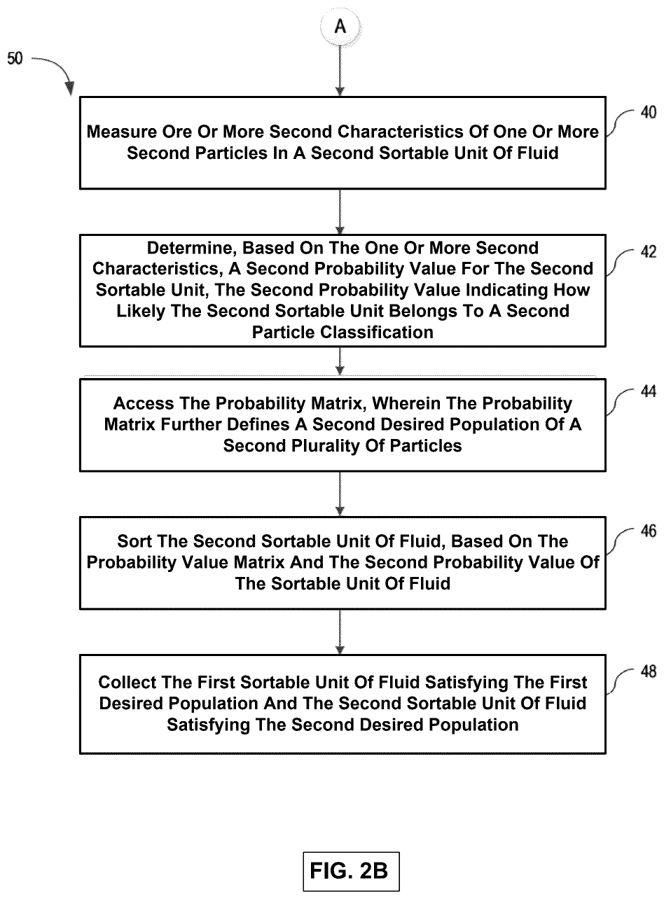

FIGS. 2A and 2B describe the use of a probability matrix defining a respective desired population of different particles by the systems and methods taught herein to sort sortable units such that the sortable units in a keep vessel have the desired population of the particles.

Those skilled in the art will appreciate that what is taught below with respect to FIGS. 2A and 2B is illustrative and not meant to limit the scope of the disclosure.

FIG. 2A is a flowchart illustrating processing steps 30 for sorting particles in accordance with some embodiments. In step 32, the particle processing system can measure one or more first characteristics of one or more first particles in a first sortable unit of fluid. For example, the particle processing system can measure one or more characteristics (e.g., scatter, extinction, fluorescence including FFL, or SFL, orientation, or the like) of one or more particles in a droplet of fluid. Examples are described with respect to FIG. 3.

In step 34, the particle processing system can determine, based on the one or more first characteristics, a first probability value for the first sortable unit of fluid. The first probability value can indicate that how likely the first sortable unit of fluid belongs to a first particle classification. Examples are described with respect to FIGS. 4, 6, 7, and 8.

In step 36, the particle processing system can access a probability matrix defining a first desired population of a first plurality of particles. For example, a probability matrix can define a percentage of A-type particles. Examples are described with respect to FIGS. 8 and 13.

In step 38, the particle processing system can sort the first sortable unit of fluid, based on the probability value matrix and the first probability value of the first sortable unit of fluid.

For example, a sortable unit can be sorted to a keep vessel such that the sortable unit can have the first desired population of a first plurality of particles (e.g., X % of A-type particles). Examples are described with respect to FIGS. 8 and 13.

FIG. 2B is a flowchart illustrating processing steps 50 for sorting at least two sortable units in accordance with some embodiments. In some embodiments, the systems and methods taught herein are able to sort particles with different characteristics in order to achieve a resulting group of particles having a desired population of particles with different characteristics, for example, a resulting group of particles that is 60% particle type A and 40% particle type B.

In step 40, continuing from the step 38, the particle processing system can measure one or more second characteristics of one or more second particles in a second sortable unit of fluid. Examples are described with respect to FIGS. 8 and 13.

In step 42, the particle processing system can determine, based on the one or more second characteristics, a second probability value for the second sortable unit. The second probability value can indicate how likely the second sortable unit belongs to a second particle classification. Examples are described with respect to FIGS. 4, 6, 7, and 8.

In step 44, the particle processing system can access the probability matrix. The probability matrix further defines a second desired population of a second plurality of particles. Examples are described with respect to FIGS. 8 and 13.

In step 46, the particle processing system can sort the second sortable unit of fluid, based on the probability value matrix and the second probability value of the sortable unit of fluid. For example, a probability matrix can define a percentage of A-type particles and a percentage of B-type particles of a desired population. Examples are described with respect to FIGS. 8 and 13.

In step 48, the particle processing system can collect the first sortable unit of fluid satisfying the first desired population and the second sortable unit of fluid satisfying the second desired population. For example, the second sortable unit can be sorted to a keep vessel such that the second sortable unit can have the second desired population of the second plurality of particles (e.g., Y % of B-type particles).

It should be understood that a probability matrix can define a respective desired population of more than two types of particles. For example, a probability matrix can define a first desired population of A-type particles, a second desired population of B-type particles, a third desired population of C-type particles and so on.

In some embodiments, the particle processing system can update the probability matrix in real time.

In some embodiments, one or more Gaussian distributions can be used by the systems and methods taught herein to support determining a probability value for the sortable unit of fluid and sorting the sortable unit of fluid based on the probability value.

FIGS. 3-7 describe the use of one or more Gaussian distributions based on bovine sperm sorting used by the systems and methods taught herein to support determining a probability value for the sortable unit of fluid and sorting the sortable unit of fluid based on the probability value. Those skilled in the art will appreciate that what is taught below with respect to FIGS. 3-7 is illustrative and not meant to limit the scope of the disclosure.

FIG. 3 illustrates an example of two Gaussian distributions based on forward fluorescence measurement (FFL) 100 of particles producing Gaussian distributions 102 and 104. Those skilled in the art will appreciate that Gaussian distributions based on other types of measurements are possible.

The gender of sperm cells can be determined by quantifying their DNA content. For most bovine breeds, the difference in DNA content between XX chromosome and XY chromosome sperm cells can be 3.8% to 4.0%. The random measurement errors (ADC quantization, PMT dark current, amplifier noise, laser noise, etc.) and the variability of the staining process (membraned permeability to the dye, DNA accessibility, unbound dye background emission, Raman scatter from the buffer, etc.) can combine to produce a Gaussian distribution of FFL intensity for particle measurements. The X and Y sperm cells can produce two, often overlapping Gaussian distributions 102 and 104, as illustrated in FIG. 3. The means of these two Gaussian distributions 102 and 104 can be separated by 3.8% to 4.0%. The precision of the measurements can limit the fraction of sperm cells for either gender that can be classified for particle sorting. While coefficient of variation (CV) can be often used to express precision, peak to valley ratio (PVR) can be adopted in sperm sorting to describe measurement resolution. As illustrated in FIG. 3, PVR can be defined as the difference between the right (X) peak distribution height and the valley height divided by the peak height. FIG. 3 illustrates a PVR of 67%. At this PVR the two distributions overlap.

FIG. 4 illustrates a table (Table 1) of parameters for a computer model of the two Gaussian distributions 102 and 104 in FIG. 3, with means separated by 3.8%, and PVR values ranging from 60% to 80%. The computer model shows the fraction of actual XX chromosome cells that can be classified as “positive” for sorting to 90% and 95% purity. At a 67% PVR from FIG. 3, the CV of the Gaussians can be 1.28%. To achieve 95% purity, illustrated by the sort boundary in FIG. 3, the computer model can predict that 90.28% of the actual X cells can be classified as positive for sorting and 4.74% of the actual Y cells can be classified as positive for sorting. This analysis reveals that at PVR>85% (CV<0.98%) more than 99% of the actual X cells are correctly classified as positive for XX gender.

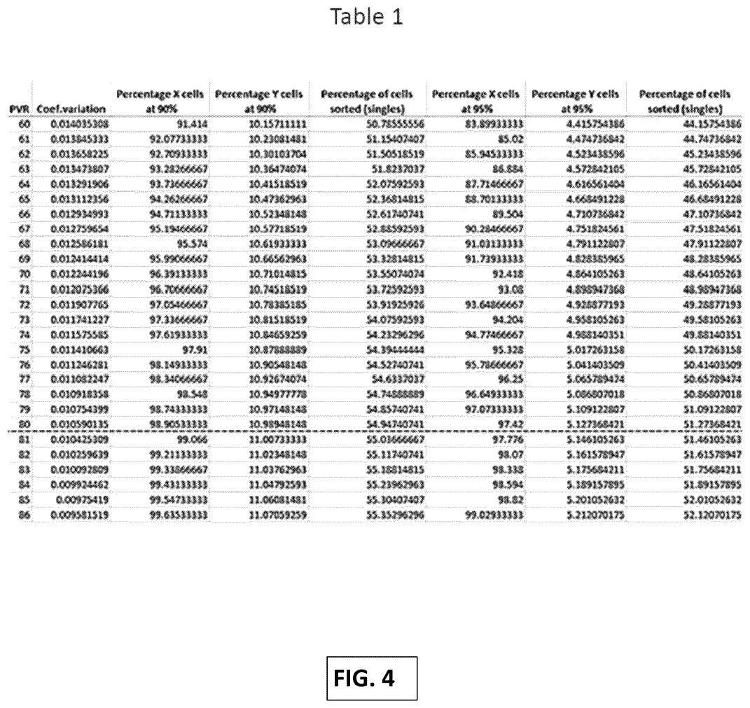

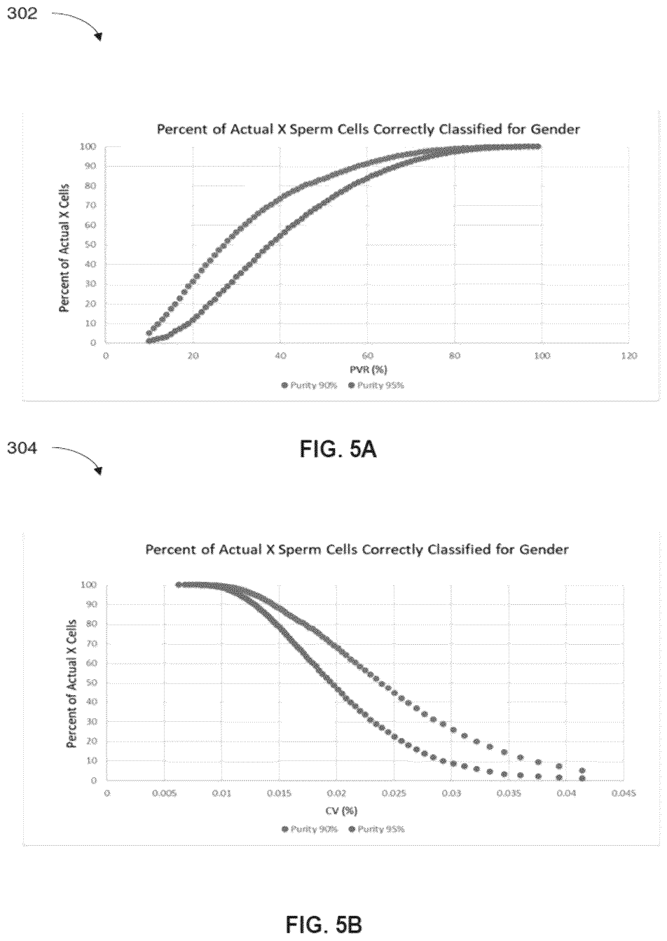

FIG. 5A is a graph 302 of a fraction of actual X cells as a function of PVR that be correctly classified as “positive” for sorting to 90% and 95% purities. FIG. 5B is a graph 304 of a fraction of actual X cells as a function of PVR that be correctly classified as “positive” for sorting to 90% and 95% purities.

FIG. 6A illustrates a histogram 410 of FFL intensity for a set of well aligned sperm cells as a function of a number of cells and a histogram 420 of FFL intensity for a set of well aligned sperm cells above a probability distribution for Pr(X) as a function of the FFL intensity in the histogram 410. FIG. 6B is a graph 430 illustrating that a dual Gaussian model is applied to raw FFL data.

FIGS. 6A and 6B illustrate how the dual Gaussian model uses raw FFL data for a specific set of oriented particles to produce a probability function in FFL. As illustrated in FIG. 6A, a dotted line 402 indicates that the FFL intensity value where particles having that value are estimated to have Pr(X)=0.90. As illustrated in FIG. 6B, raw data 432 is fitted with two overlapping Gaussian distributions 434 and 436. Based on the modeled Gaussian distributions a probability function in FLL is calculated and plotted. The FFL value representing Pr(X)-0.90 is marked with the vertical line 438. This probability function, based on actual measured data from the sample being sorted, establishes a Pr(X) for each FFL intensity value in the FFL histogram in FIG. 6A. The particle processing system can look up a Pr(X) value based on the measured FFL intensity for a corresponding particle.

FIG. 7 is a flowchart illustrating processing steps 500 for executing a dual Gaussian model in accordance with some embodiments. This method can cycle continuously on a processor during probability sorting.

In step 502, a particle processing system as taught herein can accumulate a statistically meaningful data set. For example, as illustrated in FIGS. 6A and 6B, the graphs represent data from 20,000 particles having an orientation requirement for particle processing.

In step 504, the particle processing system can histogram the statistically meaningful data set, as illustrated in FIGS. 6A and 6B.

In step 506, the particle processing system can fit a dual Gaussian model to the raw data, as illustrated in FIG. 6B.

In step 508, the particle processing system can calculate a probability distribution as a function of FFL, as illustrated in FIG. 6B.

In step 510, the particle processing system can load the probability distribution into memory accessible by the FPGA. Steps 502-510 can be repeated.

FIG. 8 is an example block diagram that summarizes processing steps 600 for probability sorting in accordance with some embodiments. The example block diagram illustrates processing of an analog output of a photodetector, but one skilled in the art will appreciate that the steps described can be modified or changed to accommodate a photodetector with a digital output. An analog output 602 from photodetectors (e.g., nine photodetectors, more than nine, or less than nine) can be input to parallel, synchronously clocked, 100 MHz analog-to-digital converters (ADCs) 604. Example photodetectors can include one or more fluorescence detector elements (e.g., silicon photomultipliers, or the like or one or more photomultiplier tubes (PMTs)). The one or more fluorescence detector elements are configured to detect fluorescence, for example, FFL or SFL or both. The resulting digital stream can be then processed by the particle processing system. The first processing step can be pulse detection 606. A valid pulse can be defined as a sequence of samples presented by one or more trigger ADC channels that meet pre-set criteria for amplitude, shape, and number. When a pulse is detected, the same temporal set of samples from each ADC channel are then presented for measurement 608 of pulse height (max sample value) and pulse area (sum of sample values). The pulse detection 606 can also assign a unique Pulse ID that is entered with a time stamp of a pulse's arrival into the sortable unit classification queue. This time stamp can be also associated with the pulse data throughout all processing steps within the FPGA. The measurement values can be then processed to obtain calculated values 610 for fluorescence including normalized FFL, average FFL, corrected SFL, FP-x, FP-y, SP-x, and SP-y. This final set of measured and calculated values for the pulse, along with the pulse ID, can be then sent online or offline by the particle processing system to an external processor 612 where a probability model and other applications that consume data are hosted. These same calculated and measured values can continue to be processed in real-time within the FPGA. These values can be used to facilitate assignment of probabilities for a pulse, for example, Pr(X) and Pr(Y). For the case of a dual Gaussian model that was tested, the pulse's SP-x and SP-y values, which describe the particle's physical orientation during measurement, can be associated with a specific set of Pr(X) and Pr(Y) lookup tables 614. The pulse's FFL value can be used to select the specific Pr(X) and Pr(Y) value from their respective lookup tables 614. These two probability values can then be assigned to the pulse. The lookup tables 614 can be accessed for these probabilities. In some embodiments, the probabilities can be calculated and downloaded from the offline processor to the particle processing system 612. In some embodiments, the probabilities can be calculated in real time by the particle processing system. Lookup tables 614 can be updated several times per minute by a processor of the particle processing system. In some embodiments, the offline processor 612 can update the lookup tables 614. The updates to the lookup tables 614 can be based on the most recent measured events (e.g., 10,000 to 20,000 particles that were measured before the current pulse being processed by the particle processing system). The Pr(X) and Pr(Y) values along with the unique Pulse ID can be then sent to the sortable unit classification queue 616 where they are temporally correlated with specific drops based on the pulse ID and associated pulse time stamp. Some sortable units can be empty. Some sortable units can have one particle. Some sortable units can have more than one particle. The sortable unit classification queue 616 can calculate a probability value, for example, an average Pr(X) and Pr(Y) for each sortable unit by summing individual pulse probabilities and dividing by the number of particles in the sortable unit. These average sortable unit probabilities can be then used for a stream assignment 618 to assign the sortable unit to a correct stream. For example, if particle count and average Pr(X) and Pr(Y) for the collection tube is maintained, then it is possible to determine whether adding the current sortable unit will lower the average collection tube probability below the pre-set current target. If it does not then the sortable unit can be added to the tube. There are many other processing rules that can be applied.

### Orientation of Particles

Described below are details of the particle processing systems and methods taught herein with respect to particles having a morphology suited for orientation relative to an interrogation zone in order to provide improved characterization of a particle.

An orientation plot can represent a relative axial angle of orientation of a particle (e.g., a sperm cell) as it passes through a laser beam on the particle processing system. The orientation plot can serve as a very stable method to differentiate particles based on their axial orientation during passage through an interrogation region of the particle processing device.

The orientation plot provides the following benefits:

Orientation parameters (e.g., SP-x and SP-y parameters or orientation parameter for other particles) can be based on ratios of the intensity measurements made by the SFL Quad detector elements. This makes orientation parameters dimensionless and insensitive to variation in fluorescence emission intensity.

Correlation between particles before and after a specific particle was investigated and found that the orientation of a particular particle does not appear to correlate to its neighbors passing either before or after it. This means that SP-x and SP-y can be random in nature, and that their dynamic range can be governed almost exclusively by the physical properties of the optical and fluidic system (i.e. they are not sample dependent).

While the fraction of the particles in each segment of the orientation scatter plot may change from sample to sample, the shape of the orientation plot and the magnitudes of the plot (max/min of SP-x and SP-y) remain stable across different samples.

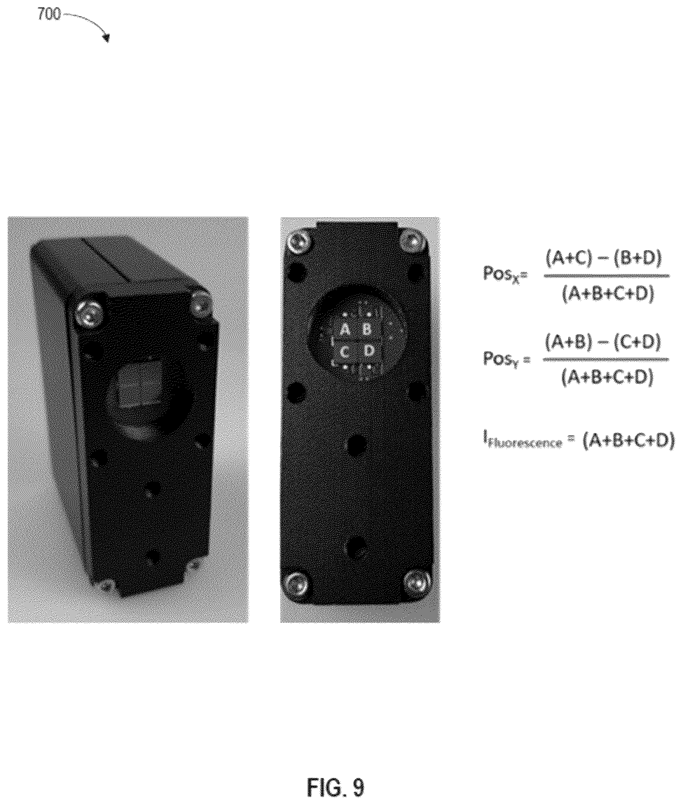

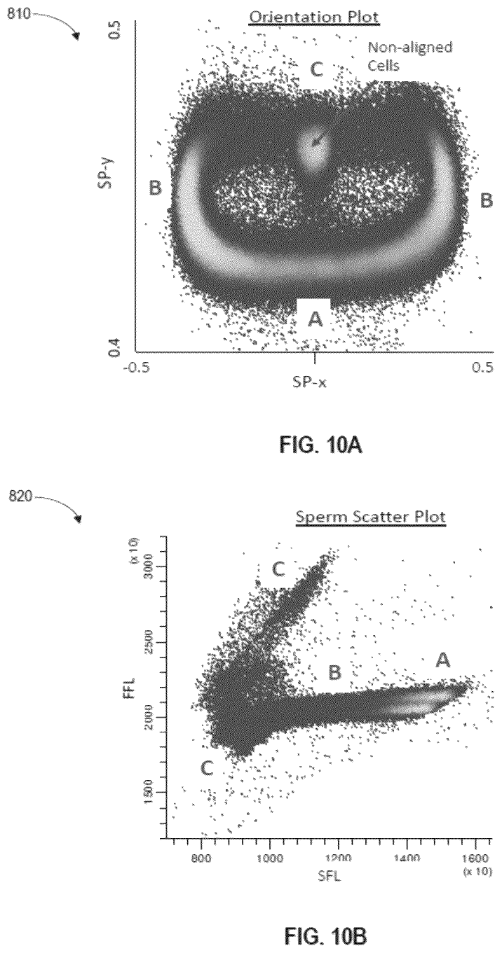

FIG. 9 illustrates an example Quad detector for orientation and calculation of orientation parameters for two-type particles e.g., X-type particles, Y-type particles. For example, a four element detector (Quad SiPM) can be attached to SFL collection optics in the manner as illustrated in FIG. 9. Two SFL orientation parameters, SP-x and SP-y, can be calculated from the four measurement outputs as illustrated in FIG. 9. When plotted as a scatter plot they form what is referred to as an orientation plot illustrated in FIG. 10A.

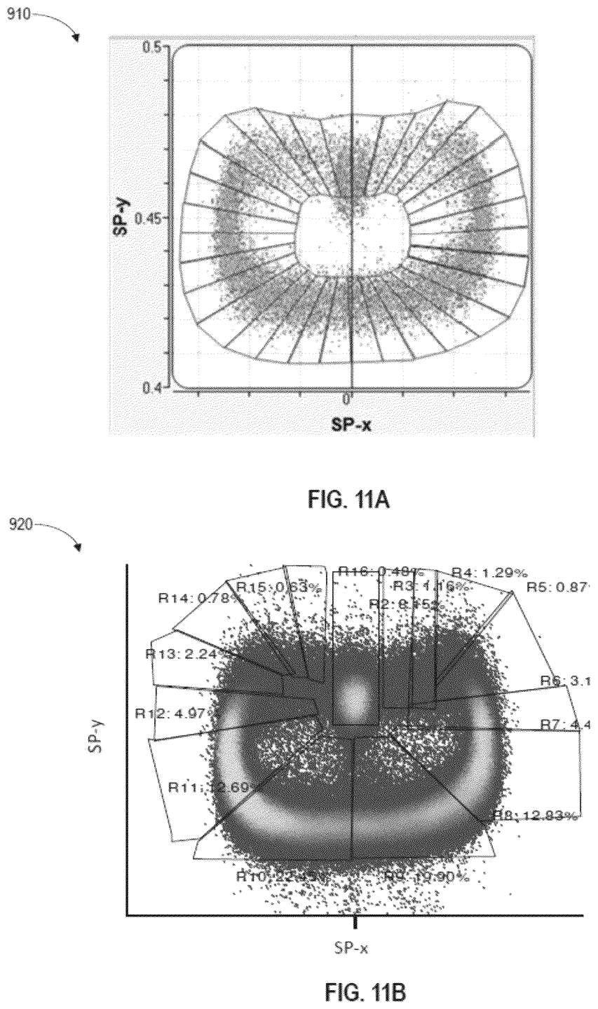

FIG. 10A is an orientation plot 810 in accordance with some embodiments. FIG. 10B is a conventional FFL vs SFL plot 820 of sperm cell measurements. The relative positions of oriented particles are labeled A, B, C. The most oriented particles are A, the less oriented, but measurable particles are B, and the non-measurable and non-oriented particles are C. The less oriented particles at B cannot be measured with the same precision as the well oriented particles at A in conventional methods as illustrated in FIG. 10B. The particle processing system as taught herein can group particles for the purpose of classification in sets of similar orientation so that the less well-discriminated particles do not reduce the discrimination precision of the well oriented particles. The particle processing system as taught herein can further automate the segmentation of the orientation plot as illustrated in FIGS. 11A and 11B.

FIG. 11A is a graph 910 illustrating contiguous regions outputted from an algorithm to automatically segment the orientation scatter plot distribution as illustrated in FIG. 10A. FIG. 11B is a graph 920 illustrating a fine segmentation having an independent output for each of sort regions in accordance with some embodiments. The fine segmentation can be used for FFL normalization calculations. A probability calculation model as taught herein can produce an independent output for each of the sort regions. The probability calculation model can be generated offline or in real time. Grouping particles into sets based on “like orientation angles” can allow the particle processing system to dynamically determine and then apply different criteria for particle classification to each set. This is, in contrast to the single, binary sort regions that have conventionally been allied to particles (e.g., all live cells). By tailoring the classification criteria based on orientation it is possible to include a higher overall fraction of particles in the sorted fraction, thus increasing overall sort yield.

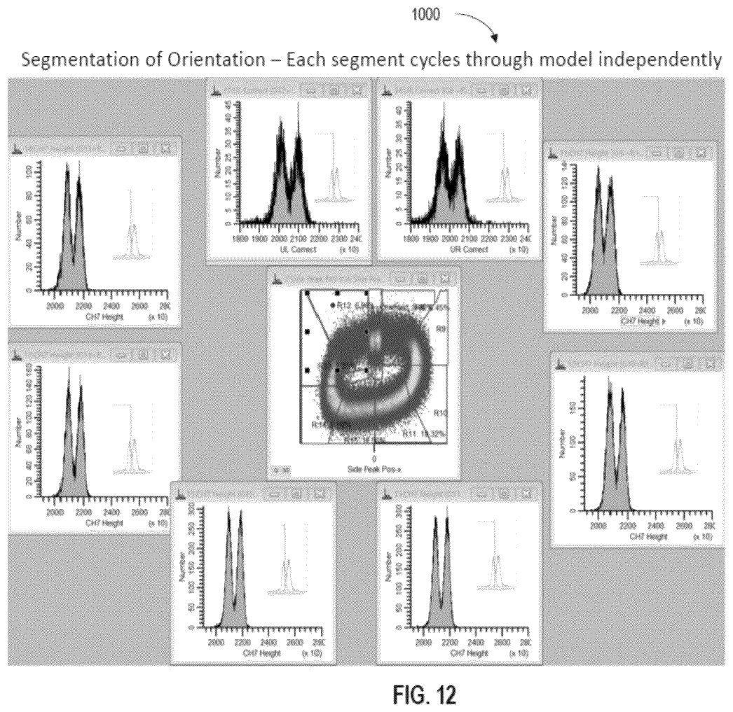

FIG. 12 illustrates an orientation scatter plot distribution 1000 segmented into eight separate sort regions in accordance with some embodiments. The probability calculation model as taught herein can sort data from the data stream it receives from the particle processing system and then process the data for each sort region segment independently. It can send an updated probability lookup table to the particle processing system as soon as calculations for the segment are complete. This means that the segments with highest percentage of particles can update more frequently. FIG. 12 illustrates how each orientation sort region has its own FFL histogram, probability model calculation, and associated probability lookup table. For example, the FPGA can be receiving eight separate lookup tables, one for each of the orientation sort regions. The lookup tables can be currently updated based on an accumulated count of new particles in each respective region. This count can often be a few thousand particles, but it can be any number. For the dual Gaussian model the number of particles accumulated in each region before applying the dual Gaussian model need only to be statistically meaningful. The example illustrates how the more optimally aligned particles exhibit a higher precision in their FFL histograms then the less optimally aligned particles.

FIG. 13 illustrates a portion of a lookup table (Table 2) created by a probability model as taught herein and uploaded to the particle processing system in accordance with some embodiments. The lookup table can associate a particular FFL intensity value for a particle in the specific orientation sort region with a Pr(X) and Pr(Y). The particle processing system can use this table to lookup probabilities for measurements in real time. A separate lookup table can be updated for each of the sort regions on orientation scatter plot distribution. The lookup table can communicate the results of the processing of the probability model in application to the particle processing system. The table includes a Pr(X) values and a Pr(Y) values for each FFL intensity increment. During real-time processing in the particle processing system, the particle processing system can use the SP-x and SP-y values to associate the particle with the correct sort region and linked lookup table. It can then use the particle's FFL intensity to lookup the Pr(X) and Pr(Y) for the particles.

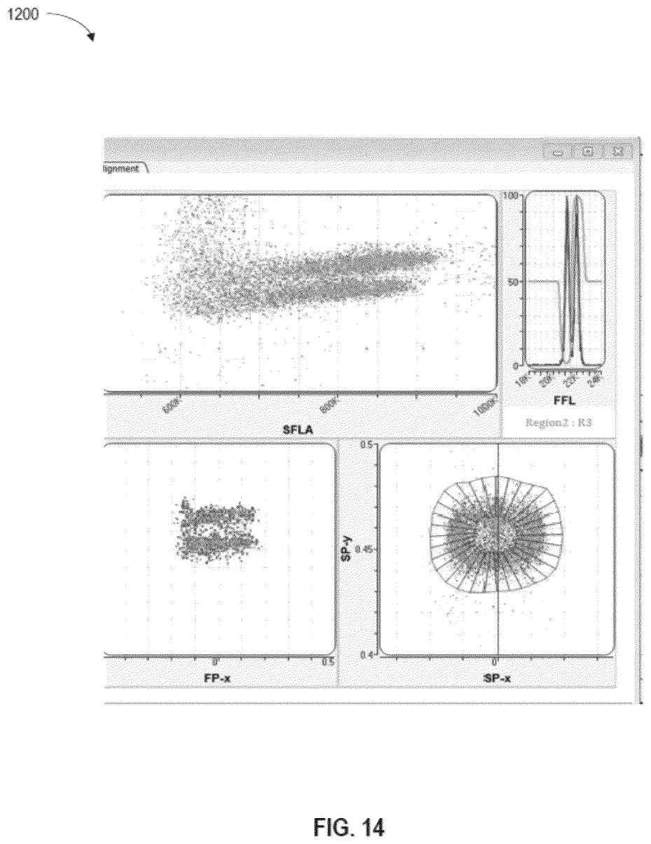

FIG. 14 illustrates an interface having an orientation plot generated by applying the particle processing system to an equine sample. The orientation plot can be at the same scale as for bovine. An equine sample was run to test the applicability of the orientation plot method to other species. While the shape and magnitude changed, the segmented plot is consistent with what was seen with bovine sample.

### Correction of FFL Measurements for Attenuation Due to Particle Orientation During Measurement

It has been well understood in the field the measured FFL intensity for less well-oriented particles is lower than the measured FFL intensity for well-oriented particles (even though the particles have the same DNA content and would produce nearly the same FFL measurement if measured at the same orientation).

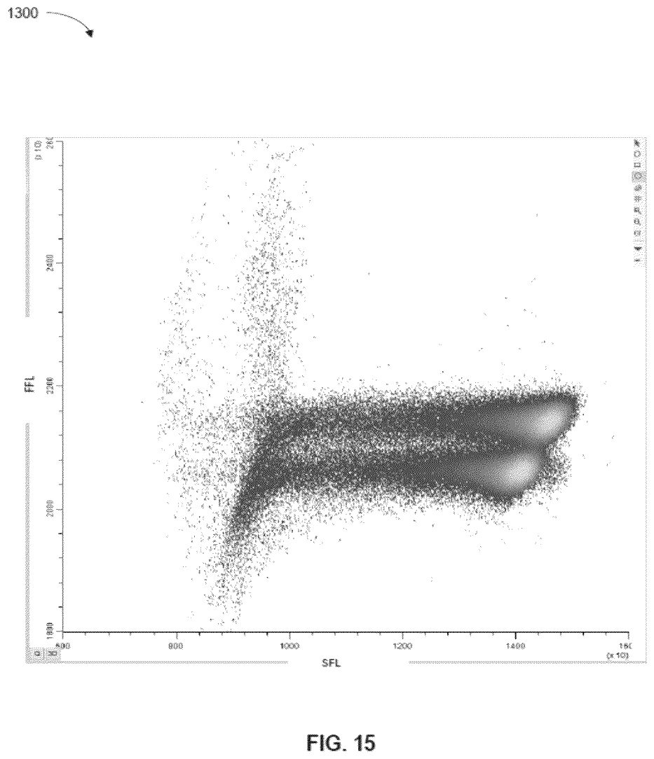

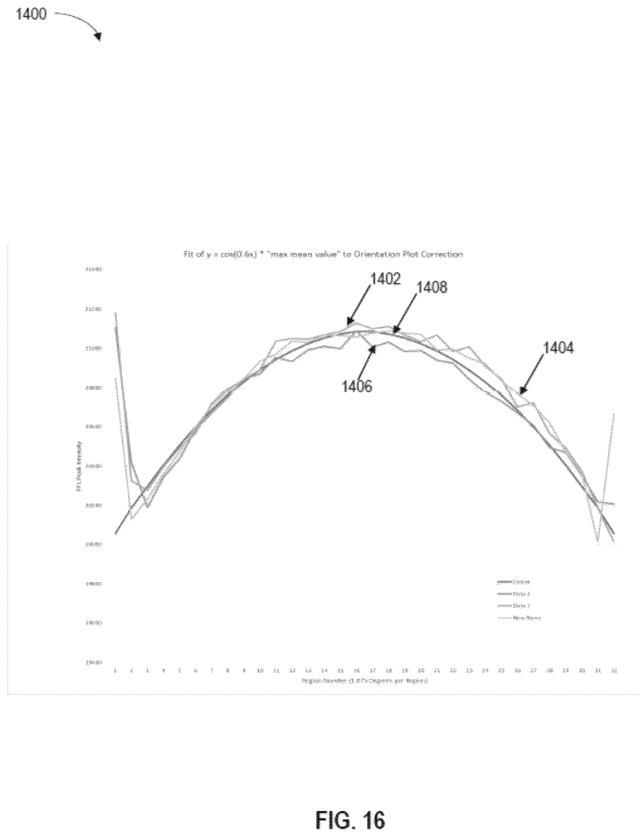

FIG. 15 is a scatter plot 1300 of FFL vs SFL for bovine sperm cells. The sortable unit in FFL intensity can be a function of SFL intensity. Since SFL provides a rough estimate of orientation, this plot suggests that measured FFL intensity varies as a function of the orientation of the particle at the time of measurement. In contrast, the orientation scatter plot provides a more precise measurement of orientation. It can be used to investigate the relationship between measured FFL intensity and sperm cell orientation relative to interrogation. By segmenting the orientation plot as illustrated in FIG. 10A and then calculating a mean FFL intensity for particles in each orientation segment it is possible to produce a graph of FFL intensity vs. Orientation angle. After measuring this on multiple samples and multiple instruments it was found that this relationship tracks closely with the measured data: FFL Intensity=cos(0.6*Orientation Angle)*Max FFL Intensity for Best Oriented Particles. The raw data and the above expression is illustrated in FIG. 16.

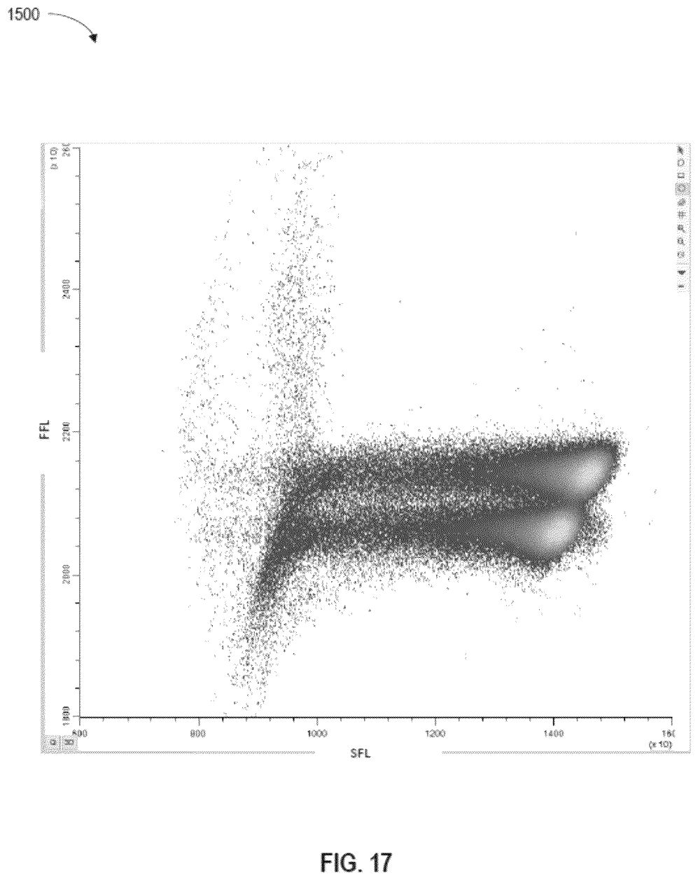

FIG. 16 is a graph 1400 illustrating raw data for measured FFL intensity for particles falling in each of thirty two orientation plot segments. There are three independent experiments using three different samples on two different particle sorters (gray 1402, orange 1406, gold 1404). The blue plot 1408 is y=cos(0.6 *angle) where region 1 is considered to be at 30 degrees and region 32 is considered to be at 330 degrees. Each region can be assumed to be a 1.875 degree increment. A correction factor can be then derived based on the mean values measured for each of the orientation plot segments. This correction factor can be then used to normalize the FFL intensity, causing measurements for each orientation plot segment to have the same or similar mean FFL intensity value, as illustrated in FIG. 17.

FIG. 17 is an FFL vs. SFL scatter plot 1500 with FFL intensity “normalized” or corrected for a measurement error caused by orientation. This normalization can improve the precision of particle classification when a model, like the dual Gaussian model, that uses FFL intensity. Conventionally, a common in sperm particle sorting is to perform a polar rotation of the data axes for FFL vs. SFL scatter plot for the purpose of improving the precision of the populations projected onto the rotated FFL axis. The normalization approach described herein and illustrated in FIG. 17 is an improvement to the polar rotation method. As previously described, the variation in measured FFL as a function of orientation is not linear. The polar rotation is suitable if it was linear. In addition, variations in overall nozzle rotation and optical alignment introduce variability from the ideal cosine function. Using the data from the segmented orientation scatter plot facilitates the correction of FFL based on actual instrument performance (e.g., optical alignment, nozzle rotation, or fluidic alignment performance), which provides a method to correct for the error in FFL measurement due to mis-orientation that is based on the current instrument performance and sample conditions, and if necessary the correction can be automatically updated should instrument performance change.

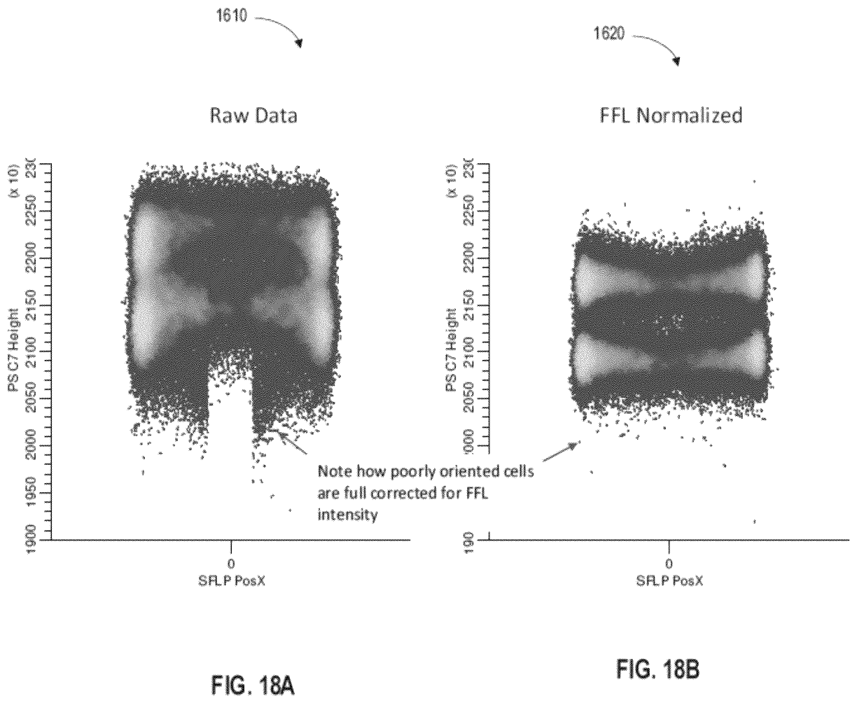

FIG. 18A is a plot 1610 of raw data of an FFL measurement. FIG. 18B is a plot of normalized FFL measurement data. FIGS. 18A and 18B illustrate how normalizing the FFL using the segmented orientation plot distribution significantly cleans up distribution of FFL intensity for all orientation angles. The fully automated FFL normalization can correct the raw data as illustrated in FIG. 18A and produce the corrected FFL measurement data as illustrated in FIG. 18B.

Optically aligned sperm cell sorters can focus a laser beam off-center from the center of the core sample stream. This is because the laser is used to provide an offset in emission intensity gain across the core stream that matches the intensity drop observed due to mis-orientation. Coupling this mis-alignment of the laser beam with the polar rotation method can enhance discrimination by FFL. This approach can be undesirable because this off-center alignment leaves the system in an unstable condition. Using the segmented orientation plot approach as taught herein for correction of particle orientation induced error in FFL measurement cam make it possible to center the beam waist on the core sample stream. This results in a more stable and easy to maintain optical alignment.

### Correction of SFL Measurement Data for Variation in Distance From the SFL Optic

Fluidic systems can be used to axially orient the sperm cells as they pass through the laser beam. The fluidic systems produces a core sample stream within a sheath stream of the particle sorter that is elliptical. On some particle sorters the core stream cross-section is often circular. This elliptical core stream exaggerates the variation in distance from the SFL light collection lens to the particle being measured. The fluorescence emission from particles closest to the lens (i.e. particles passing through on the edge of the elliptical core stream closest to the lens) can be collected with a wider angle of collection than fluorescence emission from particles furthest from the SFL lens (i.e. particles located in the edge of the elliptical core stream furthest from the SFL lens). This means that that SFL intensity varies as a function of FP-x value (relative position across the core stream at the time of measurement). An optical model constructed to simulate this SFL variation can integrate the impact of a lens system caused by the sheath-air interface if the cylindrical sheath stream.

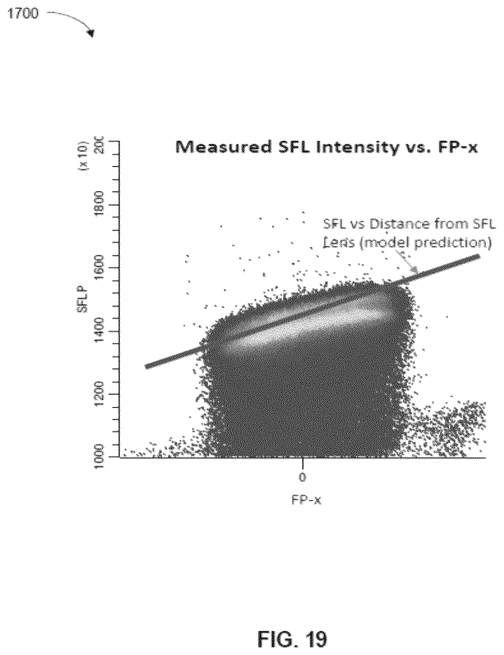

FIG. 19 is a graph 1700 illustrating a variation in measured SFL intensity as a function of FP-x. FIG. 19 summarizes how SFL measures particles differently depending on the specific x-position that they have within the sample core stream and the time of measurement. FIG. 19 shows an overlay of the model result on actual measurement data. There is reasonable correlation, however the observed data exhibit less slope that the model predicts.

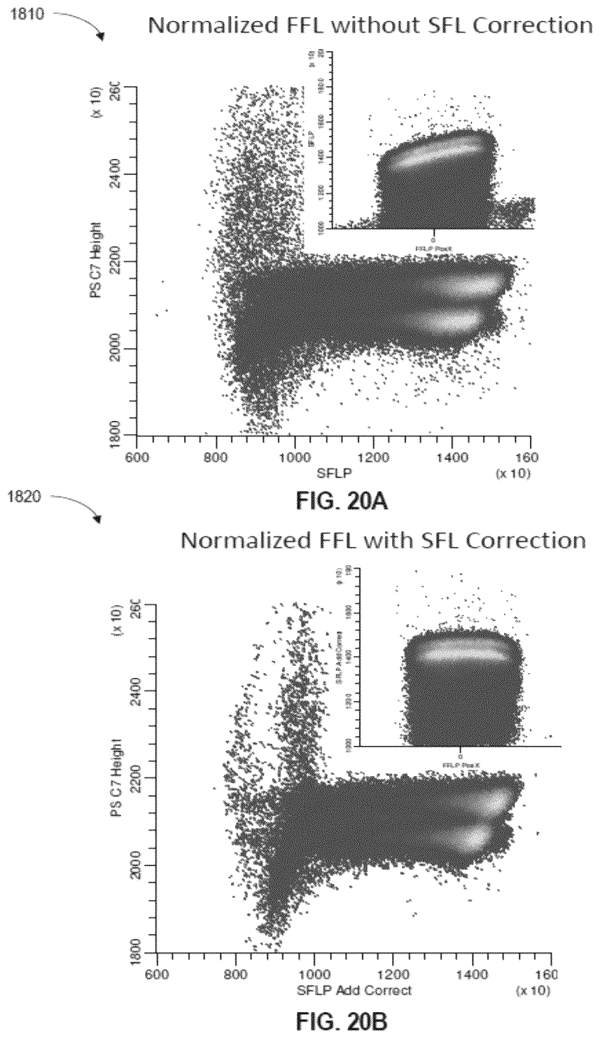

FIG. 20A is a graph 1810 illustrating normalized FFL measurement without SFL correction. FIG. 20B is a graph 1820 illustrating normalized FFL measurement with SFL correction. By measuring the actual slope of the distribution shown in FIG. 20A, it is possible to correct the measured SFL intensity for the error introduced by the relative SP-x value (core stream x-position), as illustrated in FIG. 20B.

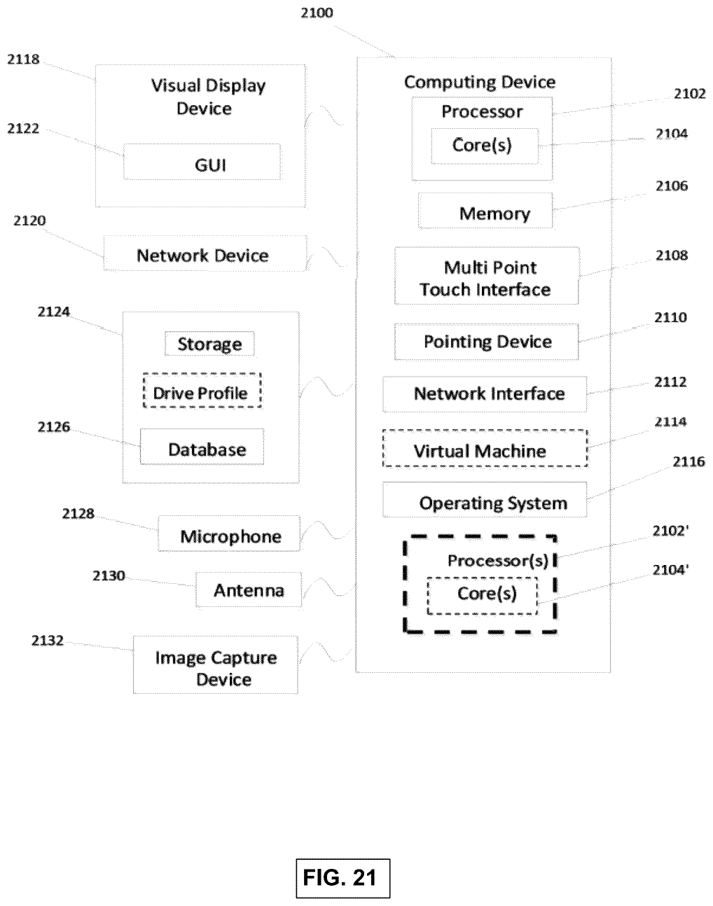

FIG. 21 is a block diagram of an exemplary computing device that can be used to perform one or more steps of the methods provided by exemplary embodiments. For example, computing device 2100 may be, but is not limited to the processing unit as described in FIG. 8. The computing device 2100 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 2106 included in the computing device 2100 can store computer-readable and computer-executable instructions or software for implementing exemplary embodiments. The computing device 2100 also includes processor 2102 (e.g., the processing unit as illustrated in FIGS. 1, 2, 7 and 8) and associated core 2104, and optionally, one or more additional processor(s) 2102′and associated core(s) 2104′(for example, in the case of computer systems having multiple processors/cores), for executing computer-readable and computer-executable instructions or software stored in the memory 2106 and other programs for controlling system hardware. Processor 2102 and processor(s) 2102′can each be a single core processor or multiple core (2104 and 2104′) processor. The computing device 2100 also includes a graphics processing unit (GPU) 2105. In some embodiments, the computing device 2100 includes multiple GPUs.

Virtualization can be employed in the computing device 2100 so that infrastructure and resources in the computing device can be shared dynamically. A virtual machine 2114 can be provided to handle a process running on multiple processors so that the process appears to be using only one computing resource rather than multiple computing resources. Multiple virtual machines can also be used with one processor.

Memory 2106 can include a computer system memory or random access memory, such as DRAM, SRAM, EDO RAM, and the like. Memory 2106 can include other types of memory as well, or combinations thereof. A user can interact with the computing device 2100 through a visual display device 2118, such as a touch screen display or computer monitor, which can display one or more user interfaces 2119. The visual display device 2118 can also display other aspects, elements and/or information or data associated with exemplary embodiments. The computing device 2100 can include other I/O devices for receiving input from a user, for example, a keyboard or any suitable multi-point touch interface 2108, a pointing device 2110 (e.g., a pen, stylus, mouse, or trackpad). The keyboard 2108 and the pointing device 2110 can be coupled to the visual display device 2118. The computing device 2100 can include other suitable conventional I/O peripherals.

The computing device 2100 can also include one or more storage devices 2124, such as a hard-drive, CD-ROM, or other computer readable media, for storing data and computer-readable instructions and/or computer executable instructions and/or models, such as a probability model as taught herein, a computation model as taught herein, or any other model as taught herein as well as one or more components or code of the system to carry out the functions described herein in relation to FIGS. 1, 2A, 2B 7 and 8 that implements exemplary embodiments of the particle processing system as described herein, or portions thereof. The one or more storage devices 2124, such as a hard-drive, CD-ROM, or other computer readable media, for storing data and computer-readable instructions and/or computer executable instructions can also include code which can be executed to generate user interface 2119 on display 2118. Exemplary storage device 2124 can also store one or more databases for storing any suitable information required to implement exemplary embodiments. The databases can be updated by a user or automatically at any suitable time to add, delete or update one or more items in the databases. Exemplary storage device 2124 can store one or more databases 2126 for storing provisioned data, and other data/information used to implement exemplary embodiments of the systems and methods described herein.

The computing device 2100 can include a network interface 2112 configured to interface via one or more network devices 2122 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 2112 can include a built-in network adapter, network interface card, PCMCIA network card, card bus network adapter, wireless network adapter, USB network adapter, modem or any other device suitable for interfacing the computing device 2100 to any type of network capable of communication and performing the operations described herein. Moreover, the computing device 2100 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 2100 can run any operating system 2116, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 2116 can be run in native mode or emulated mode. In an exemplary embodiment, the operating system 2116 can be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose.

Additionally, in some instances where a particular exemplary embodiment includes multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other embodiments, functions and advantages are also within the scope of the present disclosure.

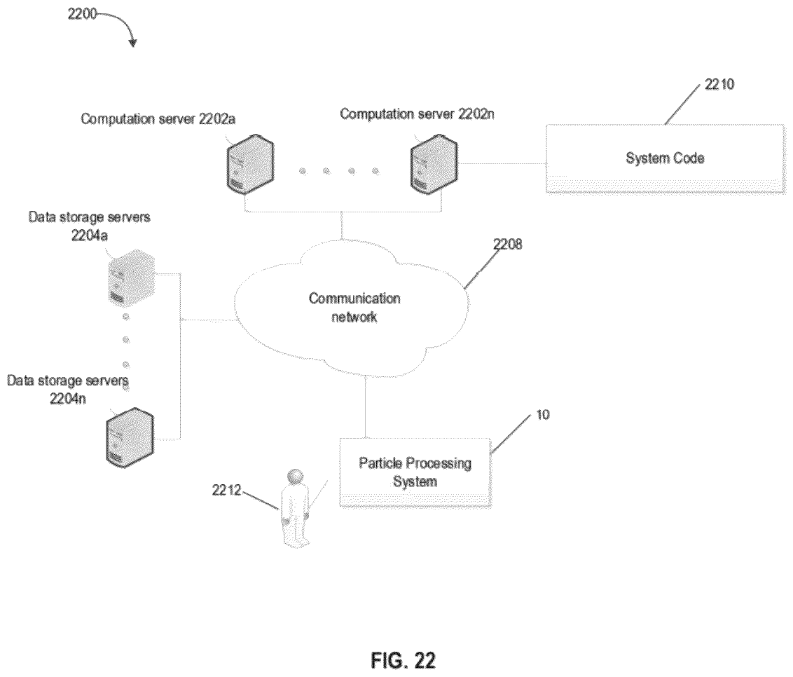

FIG. 22 is a diagram illustrating computer hardware and network components on which a system 2200 can be implemented. The system 2200 can include a particle processing system as taught herein, a plurality of computational servers 2202a-2202n having at least one processor (e.g., one or more graphics processing units (GPUs), microprocessors, central processing units (CPUs), tensor processing units (TPUs), application-specific integrated circuits (ASICs), etc.) and memory for executing the computer instructions and methods described above (e.g., FIGS. 1-3 and 8, which can be embodied as system code 2210). The system 2200 can also include a plurality of data storage servers 2204a-2204n for storing data. The computation servers 2202a-2202n, the data storage servers 2204a-2204n, and the particle processing system 10 accessed by a user 2212 can communicate over a communication network 2208.

In view of the above, it will be seen that the several objects of the invention are achieved and other advantageous results attained. As various changes could be made in the above constructions, products, and methods without departing from the scope of the invention, it is intended that all matter contained in the above description and shown in the accompanying drawings shall be interpreted as illustrative and not in a limiting sense.

### Comments on Inventive Features

Those skilled in the art will recognize that the invention described above includes many inventive aspects, including at least the following:

### A. Method of Sorting Sortable Fluid Segments

A1. A computer implemented method of sorting sortable fluid segments in a fluid stream comprising the steps of:
   measuring one or more characteristics of one or more particles in the fluid stream;
   assigning a probability to each particle that the particle belongs to a target subpopulation based on the measured characteristics;
   determining an average probability value for sortable fluid segments containing one or more particles, wherein the one or more particles in sortable fluid segments are sortable together; and
   sorting sortable fluid segments based on the average probability value of each sortable fluid segment.
A2. The computer implemented method of A1, wherein the sortable fluid segments are i) formed into droplets; ii) comprise sortable units of fluid stream by fluid switching; or iii) comprise a length of stream corresponding to a beam spot of a photo damaging laser.
A3. The computer implemented method of A1 or A2, wherein the step of determining an average probability value for a sortable fluid segment containing one or more particles further comprises:
   averaging the probabilities assigned to each of the one or more particles within the sortable fluid segment.
A4. The computer implemented method of any of A1 to A3, wherein the step of assigning a probability to each particle that the particle belongs to a target subpopulation based on the measured characteristics further comprises calculating dimensionless, fluorescence intensity insensitive values from the measured characteristics.
A5. The computer implemented method of A4 further comprising the step of determining a particle orientation with the calculated, dimensionless, intensity insensitive value.
A6. The computer implemented method of any of A1 to A5 further comprising additional target subpopulations.
A7. The computer implemented method of A6, wherein at least some particles belong to more than one of the target subpopulations.
A8. The computer implemented method of any of claims A1 to A7, wherein the particles comprises aspherical particles and the step of assigning a probability to each particle that the particle belongs to a target subpopulation based on the measured characteristics further comprises:
   determining one or more values representative of an orientation of aspherical particles based on measured characteristics;
   assigning like oriented aspherical particles to a segment within a feature space based on the one or more values representative of orientation, wherein the feature space comprises multiple segments associated with separate probability tables; and
   determining a probability value for each of the one or more aspherical particles based on a measured characteristic and the segment in which each of the one or more aspherical particles falls, wherein the probability value represents the probability an aspherical particle belongs to a target subpopulation of particles
A9. The computer implemented method of claim A8, further comprising constructing separate mathematical models for each segment in the feature space to determine the probability tables.
A10. The computer implemented method of any of A8 or A9, further comprising updating a probability table for a segment based on recent events occurring in that segment of the feature space.
A11. The computer implemented method of any of A8 to A10, wherein the determining one or more values representative of the orientation of aspherical particles further comprises:

computing a first value representative of a center of spatial intensity of fluorescence on a detector in a first dimension; and computing a second value representative of a center of spatial intensity of fluorescence on a detector in a second dimension orthogonal to the first dimension.
A12. A computer-implemented of any of A8 to A10, wherein the particles comprise aspherical cells further comprising the steps of:
   measuring one or more characteristics of aspherical particles in a fluid stream;
   determining the orientation of the aspherical particles; and
   normalizing a value representing a measured characteristic of the aspherical particles based on the orientation of the aspherical particles.
A13. The computer-implemented method of A12 further comprising the determining a probability value for the aspherical particles based on the normalized value, wherein the probability value represents probability an aspherical particle belongs to a target subpopulation of particles.
A14. The computer-implemented method of A13, wherein the determining a probability value for the aspherical particles further comprises grouping aspherical particles within segments in a feature space based on the orientation of the aspherical particles.
A15. The computer-implemented method of A14, wherein each segment in the feature space is associated with a probability look up table.
A16. The computer-implemented method of A15, wherein the probability look up tables are established with models for each segment, wherein the models are based on the normalized value representing a measured characteristic of the aspherical particles.
A17. The computer-implemented method of A16, wherein the normalizing a value representing a measured characteristic further comprises applying a correction factor to events within a segment, wherein the correction factor is the same for each event with and segment and different for each segment.

### B. Method of Analyzing Aspherical Particles

B1. A computer-implemented method of analyzing aspherical particles in a fluid stream comprising:
   determining one or more values representative of an orientation of aspherical particles based on measured characteristics;
   assigning like oriented aspherical particles to a segment within a feature space based on the one or more values representative of orientation, wherein the feature space comprises multiple segments associated with separate probability tables; and
   determining a probability value for each of the one or more aspherical particles based on a measured characteristic and the segment in which each of the one or more aspherical particles falls, wherein the probability value represents the probability an aspherical particle belongs to a target subpopulation of particles.
B2. The computer implemented method of B1 further comprising sorting aspherical particles based on the probability they belong to target subpopulation.
B3. The computer implemented method of B1 or B2, wherein the feature space comprises at least eight segments.
B4. The computer implemented method of any of B1 to B3, wherein the probability tables for each segment are periodically updated based on events occurring in each segment.
B5. The computer implemented method of any of B1 to B4, further comprising constructing separate mathematical models for each segment in the feature space to determine the probability tables.
B6. The computer implemented method of any of B1 to B5, further comprising updating a probability table for a segment based on recent events occurring in that segment of the feature space.
B7. The computer implemented method of any of B1 to B6, wherein the determining one or more values representative of the orientation of aspherical particles further comprises:
   computing a first value representative of a center of spatial intensity of fluorescence on a detector in a first dimension; and
   computing a second value representative of a center of spatial intensity of fluorescence on a detector in a second dimension orthogonal to the first dimension.
B8. The computer implemented method of any of B1 to B7, wherein the measured characteristic comprises a forward fluorescence.
B9. The computer implemented method of any of B1 to B8, wherein the one or more values representative of the orientation of aspherical particles are dimensionless.
B10. The computer implemented method of any B1 to B9, wherein the one or more values representative of the orientation of aspherical particles comprises ratio of intensity on segments of a quad detector.
B11. The computer implemented method of any B1 to B9, further comprising sorting sortable fluid segments in the fluid stream.
B12. The computer-implemented method of claims B11, wherein sortable units of the fluid stream are formed into droplets.
B13. The computer-implemented method of B11, wherein sortable units of fluid stream comprises units of fluid sortable by fluid switching.
B14. The computer-implemented method of B11, wherein sortable units of fluid comprise a length of fluid stream corresponding to a beam spot of a photo damaging laser.
B15. The computer implemented method of any of B11 to B14, further comprising: assigning a probability to each aspherical particle that the particle belongs to a target subpopulation based on the measured characteristics;
   determining an average probability value for sortable fluid segments containing one or more particles, wherein the one or more particles in sortable fluid segments are sortable together; and
   sorting sortable segments based on the average probability value of each sortable fluid segment.

### C. Method of Sorting Particles

C1. A computer-implemented method of sorting particles in a fluid stream, the method comprising:
   establishing a desired sort purity for a target subpopulation of particles in the fluid stream;
   assigning an average probability value to a sortable unit of fluid containing one or more particles; and
   collecting sortable units of fluid having a cumulative probability value equal to or higher than the desired sort purity.
C2. The computer-implemented method of C1, wherein the sortable units of fluid are formed into droplets.
C3. The computer-implemented method of C1 or C2, wherein the sortable units of fluid comprises units of fluid sortable by fluid switching.
C4. The computer-implemented method of any of C1 to C3, wherein the sortable units of fluid comprise a length of fluid stream corresponding to a beam spot of a photo damaging laser.
C5. The computer-implemented method of any of C1 to C4, wherein the assigning an average probability value to a sortable unit of fluid containing one or more particles further comprising:
   measuring one or more characteristics of one or more particles in the fluid stream; and
   determining calculated values from the measured characteristics.
C6. The computer-implemented method of any of C1 to C5, wherein the step of assigning a probability value to a sortable unit of fluid containing one or more particles further comprises:
   assigning probability values to each of the one or more particles in the sortable unit of fluid based on the calculated values associated with the particles; and
   assigning the average probability to the sortable unit of fluid based on the average of the probabilities assigned to the one or more particles within the sortable unit of fluid.
C7. The computer-implemented method of any of C1 to C6, wherein the calculated values include dimensionless values insensitive to fluorescence intensity.
C8. The computer-implemented method any of C1 to C7, further comprising additional target subpopulations.
C9. The method computer-implemented of C8, wherein at least some particles belong to more than one of the target subpopulations.
C10. The method computer-implemented any of C1 to C9, wherein the particles comprise sperm cells and the target subpopulation comprises: live X chromosome bearing sperm, live Y chromosome bearing sperm, or both.
C11. The computer implemented method of any of claims C1 to C10, wherein the particles comprises aspherical particles and the step of assigning an average probability value to a sortable unit of fluid containing one or more particles further comprises:
   determining one or more values representative of an orientation of aspherical particles based on measured characteristics;
   assigning like oriented aspherical particles to a segment within a feature space based on the one or more values representative of orientation, wherein the feature space comprises multiple segments associated with separate probability tables; and
   determining a probability value for each of the one or more aspherical particles based on a measured characteristic and the segment in which each of the one or more aspherical particles falls, wherein the probability value represents the probability an aspherical particle belongs to a target subpopulation of particles
C12. The computer implemented method of claim C11, further comprising constructing separate mathematical models for each segment in the feature space to determine the probability tables.
C13. The computer implemented method of any of C11 or C12, further comprising updating a probability table for a segment based on recent events occurring in that segment of the feature space.
C14. The computer implemented method of any of C1 to C13, further comprising: assigning a probability to each particle that the particle belongs to a target subpopulation based on the measured characteristics;
   determining an average probability value for sortable fluid segments containing one or more particles, wherein the one or more particles in sortable fluid segments are sortable together; and
   sorting sortable segments based on the average probability value of each sortable fluid segment.

### D. Method of Analyzing Aspherical Particles

D1. A computer-implemented method of analyzing aspherical particles in a fluid stream, the method comprising:
   measuring one or more characteristics of aspherical particles in a fluid stream; determining the orientation of the aspherical particles; and normalizing a value representing a measured characteristic of the aspherical particles based on the orientation of the aspherical particles.
D2. The computer-implemented method of D1 further comprising the determining a probability value for the aspherical particles based on the normalized value, wherein the probability value represents probability an aspherical particle belongs to a target subpopulation of particles.
D3. The computer-implemented method of D2, wherein the determining a probability value for the aspherical particles further comprises grouping aspherical particles within segments in a feature space based on the orientation of the aspherical particles.
D4. The computer-implemented method of D3, wherein each segment in the feature space is associated with a probability look up table.
D5. The computer-implemented method of D4, wherein the probability look up tables are established with models for each segment, wherein the models are based on the normalized value representing a measured characteristic of the aspherical particles.
D6. The computer-implemented method of D5, wherein the normalizing a value representing a measured characteristic further comprises applying a correction factor to events within a segment, wherein the correction factor is the same for each event with and segment and different for each segment.

### E. Sorting Device

E1. A sorting device for sorting particles in a fluid stream comprising:
   a channel that produces a fluid stream having particles contained therein;
   an electromagnetic radiation source for irradiating the particles at an interrogation location;
   at least one detector that produces a signal in response to irradiated particles in the fluid stream;
   a first processor configured to determined measured values and calculated values from the at least one detector signal and assign a probability value to irradiated particles and to assign an averaged probability value to sortable segments of the fluid stream containing one or more particles in real time; and
   a second processor in communication with the first processor, wherein the second processor is configured to generate probability models based on the measured and calculated values and to provide asynchronous updates to the first processor.
E2. The device of E1, wherein the channel comprises a nozzle.
E3. The device of E1, wherein the channel comprises a microfluidic channel in a chip.
E4. The device of any one of E1 to E3, wherein the asynchronous updates comprises updates to one or more look up tables used by the first processor to assign probability values to irradiated particles.
E5. The device of any one of E1 to E4, wherein at least one detector comprises a side detector, a first forward detector, and a second forward detector.
E6. The device of any one of E1 to E5, wherein at least one detector comprises a quad detector.
E7. The device of any one of E1 to E6, wherein the first processor comprises a Field Programmable Gate Array (FPGA).
E8. The device of any one of E1 to E7, wherein the second processor is an off-line processor for updating mathematical models in the background.

### F. Method of Analyzing Aspherical Particles

F1. A computer-implemented method of analyzing aspherical particles in a fluid stream comprising:
   measuring one or more characteristics of aspherical particles in a fluid stream including a side fluorescence;
   determining a relative distance from the aspherical particle to a lens collecting the side fluorescence; and
   normalizing a value representing a measured characteristic of the aspherical particles based on the relative distance from the aspherical particles to the lens collecting side fluorescence.
F2. The computer-implemented method of F1, further comprising the determining a probability value for the aspherical particles based on the normalized value, wherein the probability value represents probability an aspherical particle belongs to a target subpopulation of particles.
F3. The computer-implemented method of F1 or F2, wherein the determining a probability value for the aspherical particles further comprises grouping events representing aspherical particles within stream segments in a feature space based on the orientation of the aspherical particles.
F4. The computer-implemented method of F3, wherein each segment in the feature space is associated with a probability look up table.

### Reservation of Rights

Applicants expressly reserve all rights with respect to filing amended claims and continuation and/or divisional applications in any designated country to prosecute claims directed to any inventive aspect identified above and any other subject matter described in the specification or shown in the drawings.

What is claimed is:

1. A computer-implemented method of sorting particles in a fluid stream, the method comprising:
establishing a desired sort purity for a target subpopulation of particles in the fluid stream;
assigning an average probability value to a sortable unit of fluid containing one or more particles; and
collecting sortable units of fluid having a cumulative probability value equal to or higher than the desired sort purity.

2. The computer-implemented method of claim 1, wherein the sortable units of fluid are formed into droplets.

3. The computer-implemented method of claim 1, wherein the sortable units of fluid comprises units of fluid sortable by fluid switching.

4. The computer-implemented method of claim 1, wherein the sortable units of fluid comprise a length of fluid stream corresponding to a beam spot of a photo damaging laser.

5. The computer-implemented method of claim 1, wherein the assigning an average probability value to a sortable unit of fluid containing one or more particles further comprises:
measuring one or more characteristics of one or more particles in the sortable unit of fluid; and
determining calculated values from the measured characteristics.

6. The computer-implemented method of claim 1, wherein the step of assigning a probability value to a sortable unit of fluid containing one or more particles further comprises:
assigning probability values to each of the one or more particles in the sortable unit of fluid based on the calculated values associated with the particles; and
assigning the average probability to the sortable unit of fluid based on the average of the probabilities assigned to the one or more particles within the sortable unit of fluid.

7. The computer-implemented method of claim 1, wherein the calculated values include dimensionless values insensitive to fluorescence intensity.

8. The computer-implemented method of claim 1, further comprising additional target subpopulations.

9. The computer-implemented method of claim 8, wherein at least some particles belong to more than one of the target subpopulations.

10. The computer-implemented method of claim 1, wherein the particles comprise sperm cells and the target subpopulation comprises: live X chromosome bearing sperm, live Y chromosome bearing sperm, or both.

11. A microfluid system, comprising:
one or more processors; and
a memory encoded with instructions that, when executed by the one or more processors, cause the one or more processors to:
establish a desired sort purity for a target subpopulation of particles in the fluid stream;
assign an average probability value to a sortable unit of fluid containing one or more particles; and
collect sortable units of fluid having a cumulative probability value equal to or higher than the desired sort purity.

12. The system of claim 11, wherein the sortable units of fluid are formed into droplets.

13. The system of claim 11, wherein the sortable units of fluid comprises units of fluid sortable by fluid switching.

14. The system of claim 11, wherein the sortable units of fluid comprise a length of fluid stream corresponding to a beam spot of a photo damaging laser.

15. The system of claim 11, wherein to assign an average probability value to a sortable unit of fluid containing one or more particles further comprises causing the one or more processors to:
measure one or more characteristics of one or more particles in the sortable unit of fluid; and
determine calculated values from the measured characteristics.

16. The system of claim 11, wherein to assign an average probability value to a sortable unit of fluid containing one or more particles further comprises:
assigning probability values to each of the one or more particles in the sortable unit of fluid based on the calculated values associated with the particles; and
assigning the average probability to the sortable unit of fluid based on the average of the probabilities assigned to the one or more particles within the sortable unit of fluid.

17. The system of claim 11, wherein the calculated values include dimensionless values insensitive to fluorescence intensity.

18. The system of claim 11, wherein further comprising additional target subpopulations.

19. The system of claim 18, wherein at least some particles belong to more than one of the target subpopulations.

20. The system of claim 11, wherein the particles comprise sperm cells and the target subpopulation comprises: live X chromosome bearing sperm, live Y chromosome bearing sperm, or both.
